(19) United States
(12) Patent Application Publication
(10) Pub. No.: US 2025/0256968 A1
(43) Pub. Date: Aug. 14, 2025

(54) METHOD FOR PRODUCING CARBON NANOTUBES (CNTS) FROM EGG-DERIVED PRECURSORS AND SYSTEM THEREOF

(71) Applicant: PRINCESS NOURAH BINT ABDULRAHMAN UNIVERSITY, Riyadh (SA)

(72) Inventors: Mohd UBAIDULLAH, Riyadh (SA); Hari MOHAN SHARMA, Mathura (IN); Thamraa ALSHAHRANI, Riyadh (SA); Anuj KUMAR, Mathura (IN); Mohdmmad KHALID, Glasgow (GB); Yufeng ZHO, Shanghai (CN); Sultan MEO, Riyadh (SA)

(73) Assignee: PRINCESS NOURAH BINT ABDULRAHMAN UNIVERSITY, Riyadh (SA)

(21) Appl. No.: 19/172,257

(22) Filed: Apr. 7, 2025

(51) Int. Cl. C01B 32/162; B82Y 30/00; B82Y 40/00

(52) U.S. Cl. CPC C01B 32/162; B82Y 30/00; B82Y 40/00; C01B 2202/06; C01B 2202/32; C01B 2202/36; C01P 2002/01; C01P 2002/72; C01P 2004/03; C01P 2004/133

(57) ABSTRACT

The present invention generally relates to a method for producing high-quality carbon nanotubes (CNTs) from readily available and cost-effective egg-derived precursors. The system comprises a precursor preparation unit capable of processing egg white and/or yolk into suitable forms for pyrolysis. This unit includes options for dehydration and grinding into powder, hydrothermal treatment for solution-based precursors, and a blender for combining egg white and yolk powders in a controlled ratio to tailor the nitrogen/carbon content of the resulting CNTs. A pyrolysis reactor subjects the precursor to catalytic pyrolysis in an inert atmosphere (e.g., Argon) at temperatures between 900° C. and 1000° C., utilizing an iron (Fe) catalyst. Downstream, a purification unit removes catalyst particles and by-products. A gas flow control system maintains the inert atmosphere within the reactor, ensuring consistent CNT formation. This system offers a sustainable and scalable approach to CNT synthesis, leveraging the unique properties of egg components.

### TECHNICAL FIELD

The present disclosure relates generally to the field of nanotechnology, and more specifically to the production of carbon nanotubes (CNTs). It particularly concerns a method and system for synthesizing CNTs utilizing egg-derived precursors, offering a sustainable and cost-effective alternative to conventional CNT production methods. The invention addresses the need for efficient and environmentally friendly approaches to CNT manufacturing, leveraging readily available and naturally abundant resources.

### BACKGROUND

Carbon nanotubes (CNTs) are extensively researched nanomaterials owing to their exceptional mechanical, electrical, and thermal characteristics. The distinctive properties of CNTs, including remarkable tensile strength, superior electrical conductivity, and effective heat transfer, render them indispensable in several applications, such as improved materials, energy storage systems, sensors, and electronics. Conventionally, CNTs are produced via chemical vapour deposition (CVD), laser ablation, or arc discharge methods. These approaches, although efficient in generating high-quality CNTs, frequently necessitate substantial energy input, specialised apparatus, and the utilisation of costly and non-renewable precursor materials. Moreover, certain procedures generate harmful by-products, exacerbating environmental deterioration and elevating the manufacturing costs. These limitations underscore the necessity for more ecological, economical, and scalable approaches to CNT synthesis that reduce environmental impact and provide viable options for mass implementation.

Eggs, being plentiful and economical, are rich in organic substances such as proteins, lipids, and carbohydrates, rendering them a viable candidate for carbon precursor material. Egg whites contain proteins such as albumin, which is abundant in nitrogen and sulphur, both of which are crucial for altering the electronic characteristics of CNTs and improving their functionality for particular applications. The egg yolk, conversely, comprises lipids abundant in carbon and hydrogen, serving as an optimal carbon source during pyrolysis, the essential procedure for CNT synthesis. The amalgamation of nitrogen-dense proteins and carbon-abundant lipids renders eggs an optimal precursor for the economical and eco-friendly synthesis of CNTs.

Egg-derived materials serve as sustainable and cost-effective precursors for CNT synthesis, utilising organic waste products that would otherwise be thrown. This approach could significantly lower the cost of CNT manufacture by employing these renewable and readily accessible raw materials, in contrast to traditional approaches. Moreover, the technique is engineered for scalability, facilitating extensive production without reliance on costly or hazardous chemicals. This breakthrough aims to revolutionise conventional CNT production by utilising egg-derived ingredients to generate high-quality, functional CNTs with diminished environmental effect, heralding a new era of sustainable nanomaterial synthesis.

In view of the foregoing discussion, it is portrayed that there is a need to have a system and method for producing carbon nanotubes (CNTs) from egg-derived precursors.

### BRIEF SUMMARY

The present disclosure seeks to provide a system and method for synthesising carbon nanotubes (CNTs) from egg-derived precursors, specifically employing egg whites and egg yolk as renewable and sustainable carbon sources. The procedure employs a distinctive pyrolysis technique, incorporating regulated temperature treatment and catalytic chemicals to effectively transform the organic constituents of eggs into superior carbon nanotubes. The approach is eco-friendly, economical, and scalable, offering a feasible substitute for traditional techniques of CNT synthesis that frequently depend on petrochemical derivatives. This method utilises the inherent abundance and cost-effectiveness of eggs, addressing the demand for a sustainable carbon source while simultaneously reducing waste by repurposing egg by-products that would otherwise be thrown.

Besides its environmental advantages, the technology provides a substantial decrease in the expenses associated with CNT synthesis, sometimes a primary obstacle to the extensive commercialization of CNTs. Conventional techniques like chemical vapour deposition (CVD) and arc discharge necessitate costly raw ingredients and substantial energy consumption, while the egg-derived precursor method offers a cost-effective alternative that maintains the quality and characteristics of the resultant CNTs. The capacity to modify the structure and properties of CNTs by varying parameters such as pyrolysis temperature, precursor composition, and catalyst type allows for customisation for many applications, including energy storage devices and sophisticated materials.

This method's scalability is a notable advantage, rendering it appropriate for industrial-scale production. With appropriate optimisation, the process might be seamlessly incorporated into current industrial infrastructure, offering a cost-efficient and sustainable method for the large-scale production of CNTs. This breakthrough provides a more sustainable approach to nanomaterial synthesis and facilitates further study into bio-based CNT manufacture, thereby advancing nanotechnology in an environmentally responsible way.

In an embodiment, a system for producing carbon nanotubes (CNTs) from egg-derived precursors is disclosed. The system includes a precursor preparation unit configured to prepare an egg-derived precursor comprising at least one of egg white and egg yolk, wherein the precursor preparation unit comprises at least one of i) a dehydrator and grinder for processing egg white or egg yolk into a powder, ii) a hydrothermal treatment reactor for decomposing organic constituents of egg white or egg yolk into a solution, and iii) a blender for mixing egg white powder and egg yolk powder in a predetermined ratio to regulate nitrogen/carbon content in the resulting CNTs.

The system further includes a pyrolysis reactor operably connected to the precursor preparation unit, the pyrolysis reactor configured to subject the egg-derived precursor to catalytic pyrolysis in an inert atmosphere at a temperature between 900° C. and 1000° C. in the presence of an iron (Fe) catalyst, thereby forming CNTs.

The system further includes a purification unit operably connected to the pyrolysis reactor, the purification unit configured to purify the formed CNTs to remove catalyst particles and unreacted carbon by-products.

The system further includes a gas flow control system configured to maintain the inert atmosphere within the pyrolysis reactor.

In another embodiment, the pyrolysis reactor is a tube furnace or a fluidized bed reactor for controlled heating, wherein the precursor preparation unit is further configured to isolate egg white from egg yolk.

In one embodiment, the purification unit comprises at least one of an acid washing apparatus for removing residual catalyst particles, a centrifuge for isolating CNTs from unreacted carbonaceous material, and a drying mechanism for preparing purified CNTs.

In a further embodiment, a method for producing carbon nanotubes (CNTs) from egg-derived precursors is disclosed. The method includes preparing an egg-derived precursor comprising at least one of egg white and egg yolk, wherein preparing the egg-derived precursor comprises at least one of i) dehydrating and grinding the egg white or egg yolk into a powder, ii) hydrothermally treating the egg white or egg yolk to decompose organic constituents into a solution, iii) blending egg white powder and egg yolk powder in a predetermined ratio, and iv) hydrothermally treating the blended egg white and egg yolk powder.

The method further includes subjecting the egg-derived precursor to catalytic pyrolysis in an inert atmosphere at a temperature between 900° C. and 1000° C. in the presence of an iron (Fe) catalyst, thereby forming CNTs.

The method further includes purifying the formed CNTs to remove catalyst particles and unreacted carbon by-products.

Yet, in another embodiment, preparing the egg-derived precursor further comprises isolating egg white from egg yolk.

In one of the above embodiments, the inert atmosphere is provided by argon (Ar) or nitrogen to prevent oxidation.

In one embodiment, the Fe catalyst is infused into the precursor material.

Yet, in a further embodiment, the Fe catalyst is applied onto a support material, wherein the support material is selected from the group consisting of alumina and silica.

In another embodiment, purifying the CNTs comprises at least one of acid washing and centrifugation.

In one embodiment, the egg white is processed to isolate albumin, wherein the egg yolk is processed to isolate lipids and cholesterol.

An object of the present disclosure is to provide a new method for producing carbon nanotubes (CNTs) from organic components derived from eggs (egg whites and yolks), offering a sustainable alternative to traditional CNT synthesis methods.

Another object of the present disclosure is to reduce the production costs of CNTs by utilizing readily available and renewable organic waste materials (eggs) as precursors, eliminating the need for expensive and non-renewable precursor substances.

Another object of the present disclosure is to minimize the generation of harmful by-products and toxic emissions associated with conventional CNT production techniques, promoting a more environmentally sound and sustainable manufacturing process.

Another object of the present disclosure is to develop a CNT production process that is scalable and adaptable for industrial applications, enabling large-scale production of CNTs.

Another object of the present disclosure is to effectively convert egg-derived precursors into high-quality carbon nanotubes suitable for various applications.

Another object of the present disclosure is to create CNTs that can be utilized in diverse fields, including energy storage (batteries, supercapacitors, fuel cells, hydrogen storage), catalysis, and composite materials, enhancing their performance and durability.

Another object of the present disclosure is to produce nitrogen-doped CNTs from egg whites, which are particularly beneficial for applications in sensors, electronic devices, and environmental remediation technologies.

Another object of the present disclosure is to provide a process that allows for the customization of CNT properties (diameter, length, surface functionalization) to meet specific application requirements, including nanomedicine and aerospace engineering.

Another object of the present disclosure is to contribute to the advancement of nanotechnology and materials science by offering an environmentally friendly and economically viable solution to the growing demand for nanoparticles in modern industry.

Another object of the present disclosure is to facilitate the development of next-generation technologies focused on sustainability and efficiency through improved CNT production.

Yet another object of the present invention is to deliver an expeditious and cost-effective system for producing carbon nanotubes (CNTs) from egg-derived precursors.

To further clarify the advantages and features of the present disclosure, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF FIGURES

These and other features, aspects, and advantages of the present disclosure will become better understood when the following detailed description is read concerning the accompanying drawings in which like characters represent like parts throughout the drawings, wherein:

FIG. 1 illustrates a block diagram of a system for producing carbon nanotubes (CNTs) from egg-derived precursors in accordance with an embodiment of the present disclosure;

FIG. 2 illustrates a flow chart of a method for producing carbon nanotubes (CNTs) from egg-derived precursors in accordance with an embodiment of the present disclosure;

FIG. 3 illustrates a methodical synthesis of egg-derived CNTs in accordance with an embodiment of the present disclosure;

FIG. 4 illustrates a typical mechanism of CNTs formation during pyrolysis, emphasising the roles of both egg-derived white and yolk components in the presence of a ferrocene catalyst in accordance with an embodiment of the present disclosure;

FIG. 5(a) illustrates the interior structure of the manufactured carbon nanotubes (CNTs) as observed in transmission electron microscopy (TEM) pictures of the manufactured carbon nanotubes (CNTs) in accordance with an embodiment of the present disclosure;

FIG. 5(b) illustrates a magnified view of the interior structure of the manufactured carbon nanotubes (CNTs) as observed in transmission electron microscopy (TEM) pictures of the manufactured carbon nanotubes (CNTs) in accordance with an embodiment of the present disclosure;

FIG. 5(c) illustrates a more comprehensive perspective of the exterior morphology of the CNTs, demonstrating the creation of well-structured CNTs, as observed in scanning electron microscopy (SEM) pictures of the manufactured carbon nanotubes (CNTs) in accordance with an embodiment of the present disclosure;

FIG. 6 illustrates an X-ray diffraction (XRD) pattern of the prepared CNTs in accordance with an embodiment of the present disclosure; and

FIG. 7 illustrates an FT-IR spectra of the synthesised CNTs in accordance with an embodiment of the present disclosure.

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

To promote an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail concerning the accompanying drawings.

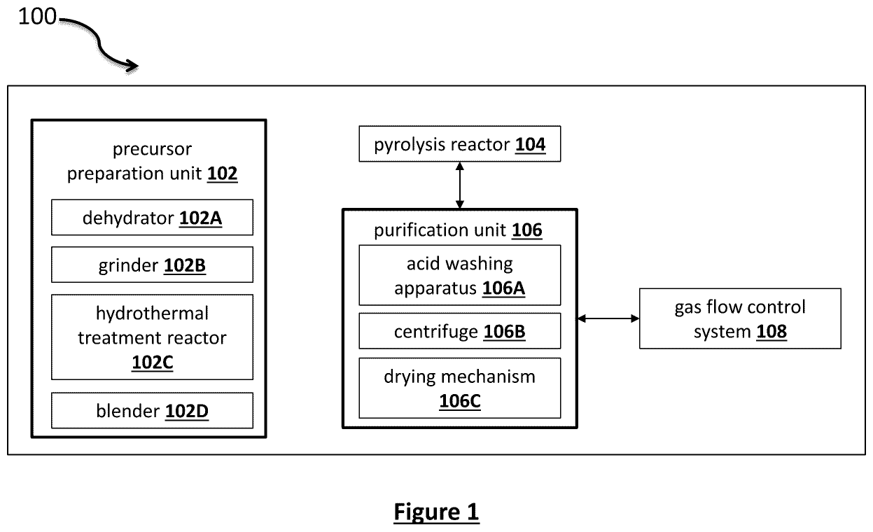

Referring to FIG. 1, a block diagram of a system for producing carbon nanotubes (CNTs) from egg-derived precursors is illustrated in accordance with an embodiment of the present disclosure. The system (100) includes a precursor preparation unit (102) configured to prepare an egg-derived precursor comprising at least one of egg white and egg yolk, wherein the precursor preparation unit (102) comprises at least one of a dehydrator (102A) and grinder (102B) for processing egg white or egg yolk into a powder, a hydrothermal treatment reactor (102C) for decomposing organic constituents of egg white or egg yolk into a solution, and a blender (102D) for mixing egg white powder and egg yolk powder in a predetermined ratio to regulate nitrogen/carbon content in the resulting CNTs.

In an embodiment, a pyrolysis reactor (104) is operably connected to the precursor preparation unit (102), the pyrolysis reactor (104) configured to subject the egg-derived precursor to catalytic pyrolysis in an inert atmosphere at a temperature between 900° C. and 1000° C. in the presence of an iron (Fe) catalyst, thereby forming CNTs.

In an embodiment, a purification unit (106) is operably connected to the pyrolysis reactor (104), the purification unit (106) configured to purify the formed CNTs to remove catalyst particles and unreacted carbon by-products; and
d) a gas flow control system (108) configured to maintain the inert atmosphere within the pyrolysis reactor (104).

In another embodiment, the pyrolysis reactor (104) is a tube furnace or a fluidized bed reactor for controlled heating, wherein the precursor preparation unit (102) is further configured to isolate egg white from egg yolk.

In a further embodiment, the purification unit (106) comprises at least one of an acid washing apparatus (106A) for removing residual catalyst particles, a centrifuge (106B) for isolating CNTs from unreacted carbonaceous material, and a drying mechanism (106C) for preparing purified CNTs.

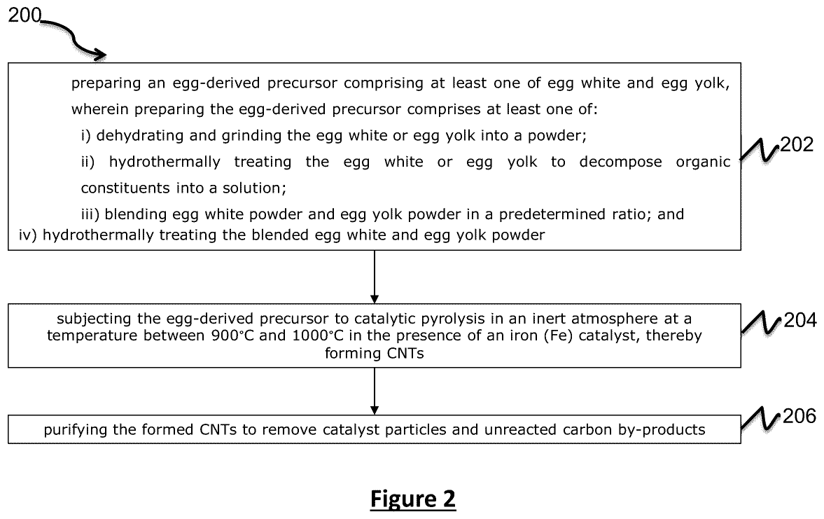

FIG. 2 illustrates a flow chart of a method for producing carbon nanotubes (CNTs) from egg-derived precursors in accordance with an embodiment of the present disclosure.

At step (202), the method (200) includes preparing an egg-derived precursor comprising at least one of egg white and egg yolk, wherein preparing the egg-derived precursor comprises at least one of dehydrating and grinding the egg white or egg yolk into a powder, hydrothermally treating the egg white or egg yolk to decompose organic constituents into a solution, blending egg white powder and egg yolk powder in a predetermined ratio, and hydrothermally treating the blended egg white and egg yolk powder.

At step (204), method (200) includes subjecting the egg-derived precursor to catalytic pyrolysis in an inert atmosphere at a temperature between 900° C. and 1000° C. in the presence of an iron (Fe) catalyst, thereby forming CNTs.

At step (206), method (200) includes purifying the formed CNTs to remove catalyst particles and unreacted carbon by-products.

In one embodiment, preparing the egg-derived precursor further comprises isolating egg white from egg yolk.

In one of the above embodiments, the inert atmosphere is provided by argon (Ar) or nitrogen to prevent oxidation.

In another embodiment, the Fe catalyst is infused into the precursor material.

In a further embodiment, the Fe catalyst is applied onto a support material, wherein the support material is selected from the group consisting of alumina and silica.

Yet, in another embodiment, purifying the CNTs comprises at least one of acid washing and centrifugation.

Yet, in a further embodiment, the egg white is processed to isolate albumin, wherein the egg yolk is processed to isolate lipids and cholesterol.

In an embodiment, preparing the egg-derived precursor further comprises isolating egg white from egg yolk, wherein the inert atmosphere is provided by argon (Ar) or nitrogen to prevent oxidation, wherein the Fe catalyst is infused into the precursor material, wherein the Fe catalyst is applied onto a support material, wherein the support material is selected from the group consisting of alumina and silica, and wherein purifying the CNTs comprises at least one of acid washing and centrifugation, and wherein the catalytic pyrolysis step is performed in a dual-zone quartz tube furnace, wherein a primary heating zone is maintained between 700° C. to 750° C. for volatilization of amino acid complexes and a secondary zone between 800° C. to 850° C. for alignment of carbonaceous vapor precursors, wherein a feed-forward gas modulation strategy is employed wherein nitrogen is introduced at a baseline flow of 100 sccm for 10 minutes to remove oxygen traces, followed by sequential introduction of hydrogen and methane gases in a ratio of 1:4, respectively, with a cumulative flow rate of 120 sccm, wherein said methane acts both as a reducing and carbon enrichment agent, and wherein a 0.5 wt % ferrocene catalyst is co-fed via sublimation at 200° C. with a ramping delay of 5 minutes to allow precursor pre-carbonization before metal-catalyzed nucleation.

In this embodiment, the preparation of the egg-derived precursor begins with isolating the egg white from the egg yolk, ensuring that the two components are separated for controlled processing. The precursor material is then subjected to an inert atmosphere, provided by gases such as argon (Ar) or nitrogen, which serve to prevent oxidation during the subsequent steps. This is a crucial step to ensure the integrity of the material and maintain the stability of the precursor during the heating process. Next, an iron (Fe) catalyst is infused into the precursor material, and it is applied onto a support material. The support material is selected from alumina (Al₂O₃) or silica (SiO₂), both of which are known for their high surface area and catalytic properties, which enhance the growth of carbon nanotubes (CNTs) by providing a stable substrate for the catalyst particles.

Following the preparation of the precursor, the CNT purification process is initiated. This involves at least one of acid washing or centrifugation to remove any residual impurities or by-products, ensuring that the final CNT product is free from unwanted contaminants. Acid washing helps to remove metal catalysts, while centrifugation aids in separating the CNTs from non-carbonaceous materials based on density differences.

The catalytic pyrolysis step is a key part of the CNT synthesis process and is carried out in a dual-zone quartz tube furnace, where precise temperature control is essential. In the primary heating zone, the temperature is maintained between 700° C. and 750° C. This range is optimized for the volatilization of amino acid complexes from the egg-derived precursor, which breaks down the proteins and lipids into smaller molecular fragments that can later form the carbonaceous vapor precursors needed for CNT formation. The secondary zone, maintained at a temperature between 800° C. and 850° C., promotes the alignment of the carbonaceous vapor precursors, helping to direct the growth of CNTs and ensuring their desired structural properties.

To further control the pyrolysis environment, a feed-forward gas modulation strategy is implemented. This involves introducing nitrogen gas at a baseline flow rate of 100 standard cubic centimeters per minute (sccm) for 10 minutes, which effectively removes oxygen traces from the system, ensuring that the environment is oxygen-deficient and suitable for the pyrolysis process.

Following this, hydrogen and methane are introduced sequentially in a 1:4 ratio, respectively, at a cumulative flow rate of 120 sccm. Methane serves dual purposes in this process: it acts both as a reducing agent, which aids in the removal of oxygen from the precursor material, and as a carbon enrichment agent, providing the necessary carbon atoms for the formation of CNTs.

Finally, a 0.5 wt % ferrocene catalyst is co-fed into the system via sublimation at 200° C. The ramping delay of 5 minutes before its introduction allows for precursor pre-carbonization, which ensures that the precursor material undergoes a gradual transformation into a carbon-rich form. This pre-carbonization step is essential to promote metal-catalyzed nucleation, which is critical for initiating the growth of CNTs. The ferrocene catalyst helps in the formation of CNTs by facilitating the breakdown of methane and the subsequent deposition of carbon onto the catalyst particles, which leads to the growth of nanotubes. The entire process is carefully controlled to ensure the formation of high-quality CNTs with the desired structural characteristics and catalytic properties.

In an embodiment, the egg white powder and egg yolk powder are blended in a predetermined ratio prior to hydrothermal treatment, the method comprising: a) measuring the egg white and egg yolk powders to achieve a mass ratio of 3:2, corresponding to a protein-to-lipid weight ratio of approximately 2.5:1, based on known proximate compositions of the two fractions; b) homogenizing the blended powders using a planetary mixer at 150 rpm for 20 minutes to ensure uniform distribution of albumin and lipid components; c) analyzing the homogenized blend using Kjeldahl nitrogen analysis and Soxhlet lipid extraction to confirm that the total nitrogen content lies within the range of 12-15 wt % and total lipid content within 5-8 wt %; d) adjusting the blend ratio incrementally by +5% based on deviations from the target nitrogen-to-lipid content window to account for batch-to-batch variability in egg composition; c) subjecting the optimized blend to hydrothermal treatment at 180° C. for 4 hours in a sealed autoclave to generate a homogeneous nitrogen- and carbon-rich precursor gel; and f) drying the hydrothermal gel in a vacuum oven at 75° C. for 10 hours, followed by catalytic pyrolysis in an argon atmosphere at 950° C. in the presence of 0.4 wt % iron catalyst supported on silica to form CNTs with tailored nitrogen doping and controlled tube morphology, as validated by elemental CHN analysis and TEM.

In this embodiment, the preparation of the egg-derived precursor involves a series of carefully controlled steps to ensure the proper composition and structure for the subsequent synthesis of carbon nanotubes (CNTs). The process begins with the precise measurement of egg white powder and egg yolk powder, which are blended in a predetermined ratio of 3:2. This ratio results in a protein-to-lipid weight ratio of approximately 2.5:1, which is selected based on the known proximate compositions of egg white and egg yolk. This balance ensures the right combination of protein and lipid content to promote the desired nitrogen- and carbon-rich matrix necessary for CNT formation.

Once the powders are measured, they are blended in a planetary mixer at 150 rpm for 20 minutes. This step ensures the uniform distribution of albumin (protein) and lipid components, which is critical for the subsequent steps. Inadequate mixing could result in uneven distribution, leading to inconsistencies in the CNTs' final structure. Following homogenization, the blend is subjected to analytical methods to confirm its chemical composition. The Kjeldahl nitrogen analysis is used to determine the nitrogen content, ensuring it falls within the range of 12-15 wt %, which is essential for the nitrogen doping of the CNTs. Meanwhile, Soxhlet lipid extraction is performed to measure the lipid content, ensuring it falls within the 5-8 wt % range. These analyses confirm that the precursor blend is within the desired compositional window, which is important for ensuring consistent CNT production.

If the nitrogen or lipid content deviates from the target values, the blend ratio is adjusted incrementally by ±5%. This adjustment helps account for natural batch-to-batch variability in the composition of the egg fractions, ensuring that each batch of precursor material is optimized for the synthesis process.

The optimized precursor blend is then subjected to hydrothermal treatment at 180° C. for 4 hours in a sealed autoclave. This treatment causes the proteins and lipids to undergo chemical transformations, generating a homogeneous nitrogen- and carbon-rich gel. The hydrothermal process ensures that the carbon and nitrogen are uniformly distributed throughout the precursor material, which is essential for the formation of CNTs with uniform doping and structural characteristics.

After hydrothermal treatment, the gel is dried in a vacuum oven at 75° C. for 10 hours. This drying step removes residual moisture from the gel, preparing it for the catalytic pyrolysis step. The dried material is then subjected to catalytic pyrolysis in an argon atmosphere at 950° C. The presence of a 0.4 wt % iron catalyst, supported on silica, facilitates the formation of CNTs. The pyrolysis conditions are optimized to produce CNTs with tailored nitrogen doping and controlled tube morphology. The process is carefully monitored and validated using elemental CHN (carbon, hydrogen, nitrogen) analysis and transmission electron microscopy (TEM), which confirm that the CNTs exhibit the desired structural properties, such as uniform tube morphology and appropriate nitrogen content. This ensures that the resulting CNTs have enhanced conductivity, electrochemical properties, and are suitable for various applications, such as energy storage or catalysis.

In an embodiment, the method 200 further comprises: a) pre-conditioning the egg-derived precursor by subjecting the isolated albumin and lipid-rich fractions to a two-stage thermal stabilization process, comprising: i) heating the albumin and lipid blend to 180° C. for 3 hours in a tubular furnace under a reducing atmosphere of 5% hydrogen in argon to induce molecular crosslinking and thermal denaturation, and ii) subsequently increasing the temperature to 320° C. for 1 hour under a pure nitrogen atmosphere to initiate low-grade carbonization and suppress spontaneous volatile evolution; b) analyzing the thermal decomposition profile of the precursor during both stages using simultaneous thermogravimetric analysis (TGA) and differential scanning calorimetry (DSC) to identify peak mass loss rates and optimize dwell times for maximum thermal stability of the intermediate carbonaceous matrix; and c) drying the thermally stabilized precursor in a vacuum oven at 80° C. for 6 hours prior to catalytic pyrolysis to remove residual moisture and minimize steam-induced disruption of CNT morphology during high-temperature synthesis.

In this embodiment, the egg-derived precursor undergoes a meticulous pre-conditioning process to improve its thermal stability and prepare it for the subsequent catalytic pyrolysis step, which is crucial for the successful formation of high-quality carbon nanotubes (CNTs). The pre-conditioning starts with subjecting the isolated albumin and lipid-rich fractions to a two-stage thermal stabilization process. The first stage involves heating the albumin and lipid blend to 180° C. for 3 hours in a tubular furnace under a reducing atmosphere of 5% hydrogen in argon. This step induces molecular crosslinking and thermal denaturation, which serves to stabilize the protein and lipid components, preventing any unwanted thermal degradation during later stages of the process. The hydrogen-rich reducing atmosphere also helps in removing oxygen and preventing oxidation, ensuring that the precursor material remains intact and ready for further processing.

After the first stage, the temperature is increased to 320° C. for 1 hour under a pure nitrogen atmosphere. This second stage initiates low-grade carbonization, which helps in the partial conversion of the precursor material into a more carbon-rich form, setting the foundation for the growth of CNTs. The nitrogen atmosphere suppresses spontaneous volatile evolution, preventing the release of gaseous by-products that could interfere with the process or compromise the quality of the resulting CNTs. By controlling the heating rate and atmosphere, this dual-stage thermal stabilization process ensures that the precursor material reaches a stable carbonaceous state, with an optimized molecular structure conducive to CNT formation.

To ensure the success of the thermal stabilization, the precursor's thermal decomposition profile is analyzed during both stages using simultaneous thermogravimetric analysis (TGA) and differential scanning calorimetry (DSC). These techniques measure the mass loss rates and thermal behavior of the material, allowing for the identification of peak mass loss temperatures and the optimization of dwell times at each temperature stage. By carefully analyzing the TGA and DSC data, the process can be fine-tuned to maximize the thermal stability of the intermediate carbonaceous matrix, which is critical for ensuring that the precursor material undergoes uniform and controlled carbonization without unwanted side reactions or degradation.

After the thermal stabilization process, the precursor is dried in a vacuum oven at 80° C. for 6 hours. This step removes any residual moisture from the thermally stabilized precursor, which could otherwise interfere with the high-temperature synthesis process during catalytic pyrolysis. Removing excess moisture helps to minimize the potential for steam-induced disruptions in the CNT morphology, ensuring that the carbon nanotubes grow with the desired structure and characteristics during the final pyrolysis step. This pre-conditioning process is essential for ensuring that the precursor is in an optimal state for the formation of CNTs with controlled morphology, uniformity, and enhanced properties, suitable for a variety of applications such as energy storage, sensors, and catalysis.

In an embodiment, the method 200 further comprises a) functionalizing the egg-derived precursor with nitrogen-rich dopant compounds by adding urea and melamine in a mass ratio of 3:1 to the hydrothermally treated egg white and yolk solution; b) stirring the dopant-infused precursor solution at 500 rpm for 1 hour at 60° C. to ensure homogeneous dispersion of nitrogen sources within the protein-lipid matrix; c) freeze-drying the dopant-infused precursor to obtain a dry nitrogen-doped solid mass; and d) subjecting the solid mass to catalytic pyrolysis under nitrogen atmosphere at 950° C. in the presence of 0.3 wt % iron nanoparticles to yield nitrogen-doped CNTs with modified graphitic domains for enhanced conductivity and electrochemical activity.

In this embodiment, the egg-derived precursor undergoes a functionalization step that introduces nitrogen-rich dopant compounds into the matrix, which is crucial for enhancing the properties of the resulting carbon nanotubes (CNTs), such as their conductivity and electrochemical activity. The process begins with the addition of urea and melamine to the hydrothermally treated egg white and yolk solution. These nitrogen-rich compounds are added in a specific mass ratio of 3:1, which is selected to provide an optimal nitrogen doping level in the final CNT product. The nitrogen atoms from urea and melamine are expected to occupy specific sites in the carbon lattice, modifying the electronic structure of the CNTs and improving their performance in applications such as energy storage or catalysis.

Once the dopants are added, the precursor solution is stirred at 500 rpm for 1 hour at 60° C. to ensure homogeneous dispersion of the nitrogen sources within the protein-lipid matrix. This step ensures that the urea and melamine molecules are evenly distributed throughout the precursor solution, allowing for consistent nitrogen doping across the entire material. Inadequate mixing could result in uneven doping, leading to variations in the quality and characteristics of the CNTs.

After the dopant infusion, the solution is freeze-dried to obtain a dry, nitrogen-doped solid mass. Freeze-drying is a critical step, as it preserves the structure and integrity of the precursor material by removing moisture without causing thermal degradation. The freeze-drying process also helps maintain the uniformity of the nitrogen doping throughout the material, which is essential for achieving consistent CNT growth and desired properties in the final product.

The dried nitrogen-doped precursor is then subjected to catalytic pyrolysis under a nitrogen atmosphere at 950° C. in the presence of 0.3 wt % iron nanoparticles. The nitrogen atmosphere ensures that the reaction occurs in an oxygen-free environment, preventing oxidation of the precursor material and preserving the nitrogen doping. The iron nanoparticles serve as catalysts, promoting the growth of CNTs and facilitating the incorporation of nitrogen atoms into the carbon lattice during the pyrolysis process. The pyrolysis conditions are optimized to promote the formation of CNTs with modified graphitic domains, which are characterized by enhanced conductivity and electrochemical activity. These modifications are critical for improving the performance of the CNTs in applications such as supercapacitors, batteries, or sensors, where conductivity and electrochemical stability are essential.

The final CNT product, enriched with nitrogen and modified graphitic domains, exhibits improved electrical and electrochemical properties, making it suitable for a wide range of advanced technological applications. The controlled pyrolysis conditions, combined with the nitrogen doping and catalytic assistance from iron nanoparticles, ensure that the CNTs are of high quality, with enhanced performance characteristics compared to traditional CNTs.

In an embodiment, the method 200 further comprises a) dispersing graphene oxide flakes at a concentration of 0.2 wt % in deionized water via ultrasonication at 40 kHz for 30 minutes; b) mixing the graphene oxide dispersion with the egg-derived precursor blend comprising powdered egg yolk and egg white in a 1:1 weight ratio; c) homogenizing the mixture using high-shear mixing at 1000 rpm for 45 minutes to allow interfacial π-π interactions between aromatic amino acid residues and the graphene oxide sheets; d) drying the resulting composite material under vacuum at 70° C. for 8 hours to form a graphene-integrated precursor powder; and c) subjecting the dried precursor to catalytic pyrolysis in argon at 980° C. with iron catalyst support on alumina to form coaxial CNT-graphene nanostructures with enhanced charge transport characteristics.

In this embodiment, the preparation of carbon nanotubes (CNTs) is enhanced through the integration of graphene oxide into the egg-derived precursor material, creating a composite material that combines the benefits of both CNTs and graphene. The process begins by dispersing graphene oxide flakes at a concentration of 0.2 wt % in deionized water. Ultrasonication is used at 40 kHz for 30 minutes to break down the graphene oxide sheets and ensure a homogeneous dispersion of the flakes in the solution. Ultrasonication helps to exfoliate the graphene oxide, breaking up larger aggregates and allowing for better dispersion in the solvent, which is essential for the subsequent steps.

Once the graphene oxide dispersion is prepared, it is mixed with the egg-derived precursor blend, which comprises powdered egg yolk and egg white in a 1:1 weight ratio. The specific ratio of egg yolk and egg white is selected to optimize the protein-to-lipid content, ensuring that the resulting composite material has the right balance of carbon and nitrogen sources necessary for CNT formation. The mixture is then homogenized using high-shear mixing at 1000 rpm for 45 minutes. This high-shear mixing ensures the formation of interfacial π-π interactions between the aromatic amino acid residues in the egg proteins and the graphene oxide sheets. These interactions enhance the compatibility between the graphene oxide and the protein-lipid matrix, promoting the formation of a stable composite material where graphene oxide is effectively integrated into the precursor matrix.

After homogenization, the composite mixture is dried under vacuum at 70° C. for 8 hours. This drying step removes residual moisture, leaving behind a graphene-integrated precursor powder. The vacuum environment helps to accelerate the drying process while preventing any oxidation or degradation of the materials. The resulting composite precursor powder is now ready for the catalytic pyrolysis step.

The dried graphene-integrated precursor powder is subjected to catalytic pyrolysis in an argon atmosphere at 980° C., with an iron catalyst supported on alumina. The iron catalyst plays a critical role in facilitating the formation of CNTs by promoting the decomposition of carbon precursors and aiding in the nucleation and growth of CNTs. The presence of graphene oxide within the precursor matrix influences the CNT growth, encouraging the formation of coaxial CNT-graphene nanostructures. These nanostructures exhibit enhanced charge transport characteristics due to the synergistic effects of the CNTs and graphene. The graphene oxide acts as a conductive scaffold, improving the electron mobility within the structure, which is particularly beneficial for applications such as energy storage devices (e.g., supercapacitors and batteries) and sensors where high conductivity and efficient charge transport are essential.

The final product, consisting of coaxial CNT-graphene nanostructures, is expected to exhibit significantly enhanced electrochemical properties compared to CNTs alone, making it highly suitable for advanced applications requiring high conductivity, mechanical strength, and stability. The integration of graphene with CNTs also improves the structural integrity and charge storage capacity of the material, offering superior performance in various electronic and energy storage systems.

In an embodiment, the method 200 further comprises a) adjusting the pH of the blended egg white and yolk hydrolysate to a controlled range of 7.2 to 7.6 using ammonium bicarbonate as a buffering agent to promote Maillard reaction pathways; b) heating the pH-adjusted mixture to 135° C. under an oxygen-deficient atmosphere (O₂ concentration <1%) for 2 hours to induce thermochemical conversion of protein and lipid fractions into heterocyclic intermediates; c) monitoring the Maillard reaction progression using Fourier-transform infrared (FTIR) spectroscopy, focusing on absorption peaks at 1540 cm 1 and 1635 cm 1 corresponding to imidazole ring and Schiff base formation; and d) terminating the reaction when the peak intensity ratio (I₁₅₄₀/I₁₆₃₅) reaches a value between 0.85 and 1.05, followed by vacuum drying at 60° C. for 12 hours to preserve the dopant-rich matrix for subsequent carbonization.

In this embodiment, the preparation of the egg-derived precursor involves a series of steps designed to promote the Maillard reaction, a complex thermochemical process that results in the formation of nitrogen-containing heterocyclic intermediates. These intermediates play a key role in modifying the properties of the final carbon nanotubes (CNTs) and enhancing their electrochemical performance. The process begins with adjusting the pH of the blended egg white and yolk hydrolysate to a controlled range of 7.2 to 7.6 using ammonium bicarbonate as a buffering agent. This pH adjustment is critical because it creates the optimal environment for the Maillard reaction to occur, ensuring the formation of the desired nitrogen-rich intermediates that will later serve as dopants in the CNT structure.

Once the pH is adjusted, the mixture is heated to 135° C. under an oxygen-deficient atmosphere, where the oxygen concentration is kept below 1%. This low-oxygen environment is essential to prevent oxidation of the proteins and lipids, ensuring that the reaction proceeds under controlled conditions. The heating process induces the thermochemical conversion of the protein and lipid fractions into heterocyclic intermediates, which are key for introducing nitrogen doping into the CNTs. These intermediates, formed through the Maillard reaction, contribute to the modification of the carbon lattice in the CNTs, improving their conductivity and electrochemical properties.

During the Maillard reaction, the progress is carefully monitored using Fourier-transform infrared (FTIR) spectroscopy. The FTIR analysis focuses on two specific absorption peaks at 1540 cm 1 and 1635 cm 1, which correspond to imidazole ring and Schiff base formation, respectively. These functional groups are indicative of the formation of nitrogen-rich intermediates that are essential for the desired doping effect in the final CNTs. By analyzing the intensity ratio of these peaks, the reaction's progression can be tracked in real-time. The reaction is terminated when the peak intensity ratio (I1540/I₁₆₃₅) reaches a value between 0.85 and 1.05. This specific ratio ensures that the Maillard reaction has proceeded sufficiently to produce the desired nitrogen-containing intermediates, without over-oxidizing or degrading the material.

After the Maillard reaction reaches the desired stage, the reaction mixture is subjected to vacuum drying at 60° C. for 12 hours. This drying step helps to preserve the dopant-rich matrix formed during the Maillard reaction by removing excess moisture. The vacuum environment ensures that the drying process does not introduce any unwanted oxidation or degradation, maintaining the integrity of the nitrogen-rich intermediates. The dried material is now ready for the subsequent carbonization step, where it will be subjected to higher temperatures to convert the matrix into carbon and form CNTs with the desired nitrogen doping and structural characteristics. The careful control of the Maillard reaction and drying process is essential to achieving a final CNT product with enhanced properties for applications in energy storage, catalysis, and other high-performance fields.

In an embodiment, the method 200 further comprises a) adding ethylenediaminetetraacetic acid (EDTA) at a concentration of 0.25 M to the egg-derived precursor blend during hydrothermal treatment; b) maintaining the chelating reaction at 70° C. for 2 hours under continuous stirring to form metal-EDTA complexes with naturally occurring calcium, magnesium, and iron ions; c) centrifuging the solution at 8000 rpm for 10 minutes to separate unbound components and obtain a clarified chelated precursor suspension; d) drying the chelated precursor at 90° C. for 10 hours under vacuum conditions to yield a fine powder; and e) subjecting the powder to catalytic pyrolysis in a dual-zone furnace with temperature zones set at 750° C. and 850° C. to obtain CNTs with narrow wall numbers and controlled inner diameters.

In this embodiment, the process begins with the addition of ethylenediaminetetraacetic acid (EDTA) at a concentration of 0.25 M to the egg-derived precursor blend during hydrothermal treatment. EDTA is a strong chelating agent that binds to metal ions, such as calcium, magnesium, and iron, which are naturally present in the egg material. The addition of EDTA ensures that these metal ions are effectively chelated, preventing them from interfering with the subsequent catalytic pyrolysis process and promoting the formation of carbon nanotubes (CNTs) with specific structural characteristics.

The chelation reaction is maintained at 70° C. for 2 hours under continuous stirring. This heating step facilitates the formation of stable metal-EDTA complexes with the naturally occurring metal ions. The continuous stirring ensures that the EDTA is well-distributed throughout the precursor blend, allowing for efficient chelation and ensuring that the metal ions are evenly complexed, which is critical for controlling the nucleation sites during CNT formation. The chelated metal ions play an important role in guiding the formation of the CNTs during the later stages of pyrolysis by influencing the catalyst behavior and promoting a more controlled CNT growth process.

Once the chelation reaction is complete, the solution is subjected to centrifugation at 8000 rpm for 10 minutes. This step helps to separate the unbound components from the chelated precursor suspension, ensuring that only the desired chelated material remains. The centrifugation process effectively clarifies the solution, removing any undissolved or unwanted by-products that could negatively impact the quality of the CNTs.

After centrifugation, the clarified chelated precursor suspension is dried at 90° C. for 10 hours under vacuum conditions. The vacuum drying process is critical for removing any residual moisture, ensuring that the chelated precursor material is in a fine, dry powder form that is suitable for the subsequent catalytic pyrolysis step. The vacuum environment prevents oxidation or degradation of the material during drying, helping to preserve the integrity of the chelated precursor and ensuring that it is ready for carbonization.

Finally, the dried chelated precursor powder is subjected to catalytic pyrolysis in a dual-zone furnace, where the temperature zones are set at 750° C. and 850° C. The dual-zone heating allows for controlled thermal decomposition, with the primary heating zone at 750° C. promoting the volatilization of the precursor material and the secondary zone at 850° C. facilitating the alignment and growth of CNTs. The use of a dual-zone furnace ensures that the CNTs are formed with narrow wall numbers and controlled inner diameters, which are essential for achieving the desired electrochemical properties and mechanical strength. The controlled pyrolysis process ensures that the metal-EDTA complexes are effectively decomposed, allowing the metal catalysts to promote the formation of CNTs with the desired structure and characteristics.

The resulting CNTs exhibit narrow wall numbers and precise inner diameters, which are essential for applications in energy storage, sensors, and other advanced technologies. The chelation step plays a critical role in optimizing the quality and consistency of the CNTs by ensuring that the metal catalysts are properly distributed and that the growth process is well-controlled, leading to high-performance CNTs with tailored structural properties.

In an embodiment, the method 200 further comprises a) suspending the egg-derived precursor blend in a 3 wt % aqueous gelatin solution maintained at 45° C. for 20 minutes to induce hydrogen bonding interactions and form a uniform viscoelastic matrix; b) casting the gelatin-precursor mixture into cylindrical molds and subjecting it to unidirectional freezing by placing the mold base in contact with a liquid nitrogen-cooled copper substrate, resulting in the formation of vertically aligned ice-Templated microchannels; c) freeze-drying the casted samples at −50° C. under vacuum for 48 hours to sublimate the ice crystals and retain aligned porosity; d) pyrolyzing the freeze-dried structures in a horizontal tubular furnace at 920° C. for 1 hour under flowing nitrogen in the presence of 0.2 wt % iron catalyst deposited on silica spheres; and c) producing vertically aligned CNTs that exhibit capillary-guided orientation due to the preserved anisotropic porosity of the freeze-cast hydrogel template.

In this embodiment, the preparation of carbon nanotubes (CNTs) is enhanced through a template-assisted process, where a hydrogel-based approach is used to guide the formation of vertically aligned CNTs with well-defined structural properties. The process begins by suspending the egg-derived precursor blend in a 3 wt % aqueous gelatin solution, which is maintained at 45° C. for 20 minutes. This temperature is carefully chosen to allow the gelatin to dissolve and form a uniform solution while promoting hydrogen bonding interactions between the gelatin and the precursor blend. The hydrogen bonding interactions are critical for forming a viscoelastic matrix, which will serve as a structural scaffold during the subsequent freeze-casting step.

After achieving a uniform matrix, the gelatin-precursor mixture is cast into cylindrical molds. These molds are then subjected to unidirectional freezing by placing the mold base in contact with a liquid nitrogen-cooled copper substrate. The freezing process is highly controlled and leads to the formation of ice crystals in a unidirectional manner, thereby creating vertically aligned microchannels within the matrix. The alignment of these microchannels is key for promoting the capillary-guided orientation of the CNTs during the subsequent pyrolysis step, as the pores formed by the ice crystals will guide the CNTs in a vertical direction, ensuring their proper orientation.

Once the freeze-casting is complete, the casted samples are subjected to freeze-drying at −50° C. under vacuum for 48 hours. This step allows for the sublimation of the ice crystals, effectively removing the ice without melting it, and preserving the aligned porosity within the hydrogel template. The freeze-drying process ensures that the structure retains its aligned microchannel network, which will later guide the formation of vertically aligned CNTs. Additionally, the vacuum environment prevents the degradation or oxidation of the material during the drying process, ensuring that the integrity of the precursor blend is maintained.

The freeze-dried structures are then subjected to pyrolysis in a horizontal tubular furnace at 920° C. for 1 hour under flowing nitrogen. The nitrogen atmosphere is essential to prevent oxidation during the high-temperature process, ensuring that the precursor material undergoes carbonization without degradation. The presence of a 0.2 wt % iron catalyst, deposited on silica spheres, promotes the formation of CNTs. The catalyst plays a crucial role in facilitating the nucleation and growth of the CNTs during pyrolysis. The pyrolysis conditions are optimized to allow the precursor material to convert into CNTs while maintaining the structural integrity of the aligned microchannels.

The final product consists of vertically aligned CNTs, which exhibit capillary-guided orientation due to the preserved anisotropic porosity of the freeze-cast hydrogel template. This orientation is beneficial for applications where directional electron transport is important, such as in energy storage devices (e.g., supercapacitors) or sensors, where aligned CNTs can improve conductivity and enhance performance. The freeze-casting technique allows for precise control over the CNT alignment, ensuring that the final structure has enhanced properties, including improved mechanical strength, electrical conductivity, and electrochemical performance.

In an embodiment, further comprising: a) electrostatically atomizing the egg-derived precursor solution using a high-voltage DC field of 16 kV to generate microdroplets with a mean diameter below 10 μm; b) depositing the atomized droplets onto a rotating ceramic drum pre-heated to 250° C. to achieve partial carbonization and shell-core microsphere formation through rapid solvent evaporation and protein-lipid phase separation; c) collecting the microspheres and subjecting them to a staged heating protocol comprising 1 hour at 400° C. and then 30 minutes at 800° C. under argon atmosphere to induce thermal cracking and hierarchical pore formation; d) introducing 5 wt % of a metal-organic framework (MOF) precursor selected from ZIF-67 into the microsphere matrix prior to final pyrolysis; and c) decomposing the MOF during pyrolysis to yield embedded cobalt nanoparticles, thereby initiating radially outward CNT growth from the microsphere cores to form flower-like multi-walled nanotube architectures with dual-modal porosity.

In this embodiment, a sophisticated process is employed to synthesize carbon nanotubes (CNTs) with unique structural features, including multi-walled nanotube architectures and dual-modal porosity, by using an egg-derived precursor and incorporating a metal-organic framework (MOF) to guide CNT growth. The process begins by electrostatically atomizing the egg-derived precursor solution using a high-voltage DC field of 16 kV. This high-voltage field generates microdroplets with a mean diameter of less than 10 μm, which is essential for achieving a uniform distribution of the precursor material during subsequent steps. The fine microdroplets are created to ensure a high surface-area-to-volume ratio, which is critical for effective carbonization and the subsequent formation of CNTs.

The atomized droplets are then deposited onto a rotating ceramic drum pre-heated to 250° C. The heat from the drum initiates the partial carbonization of the droplets and facilitates the formation of shell-core microspheres. The rapid solvent evaporation causes phase separation between the protein and lipid components of the egg-derived precursor, resulting in the formation of microspheres with a core-shell structure. The ceramic drum's rotation ensures uniform deposition of the droplets, while the heat ensures that the microspheres form consistently across the substrate. This step is crucial for creating a precursor that will later undergo controlled pyrolysis to form CNTs.

After collecting the shell-core microspheres, they are subjected to a staged heating protocol to induce further carbonization and pore formation. The microspheres are first heated for 1 hour at 400° C. to promote low-temperature carbonization and structural stability. Then, the temperature is increased to 800° C. for 30 minutes under an argon atmosphere, where the high temperature induces thermal cracking and hierarchical pore formation within the microspheres. The argon atmosphere is used to prevent oxidation during this high-temperature step, allowing the material to undergo thermal transformations without degradation. The resulting microspheres now possess a defined internal structure, with pores that will play a crucial role in the later stages of CNT formation.

Before the final pyrolysis, 5 wt % of a metal-organic framework (MOF) precursor, selected from ZIF-67, is introduced into the microsphere matrix. ZIF-67 is a cobalt-based MOF, and its introduction serves two key purposes. First, the MOF acts as a sacrificial template, providing a source of cobalt nanoparticles that will become embedded within the carbon structure during the pyrolysis step. Second, the MOF helps guide the radial growth of CNTs by serving as a catalyst for nucleation. The addition of ZIF-67 ensures that the final CNTs have a more controlled growth pattern and enhanced catalytic activity, leading to the formation of multi-walled CNTs.

The final step of the process is the pyrolysis of the MOF-infused microspheres. During pyrolysis, the ZIF-67 decomposes, releasing cobalt nanoparticles, which act as catalysts for the growth of CNTs from the core of the microspheres. The pyrolysis is conducted at high temperatures, leading to the formation of flower-like multi-walled nanotube architectures. The cobalt nanoparticles promote radially outward CNT growth from the microsphere cores, resulting in well-defined CNT structures with hierarchical porosity. The dual-modal porosity (micropores and mesopores) is generated during the thermal cracking and pyrolysis stages, contributing to enhanced surface area and improved electrochemical properties of the final CNTs. This structure is ideal for applications such as energy storage (e.g., supercapacitors and batteries), where high surface area, conductivity, and structural stability are critical.

In summary, this embodiment produces CNTs with flower-like architectures and dual-modal porosity by leveraging electrostatic atomization, MOF templating, and controlled pyrolysis. The process ensures high-quality CNTs with tailored structural and electrochemical properties, suitable for advanced technological applications.

In an embodiment, the method 200 further comprises a) exposing the dry egg-derived precursor powder to xenon difluoride (XeF₂) vapor under vacuum conditions of 10⁻⁴ Torr for 2 hours to achieve partial fluorination of peptide backbone nitrogen sites; b) storing the fluorinated powder in an inert argon environment for at least 12 hours to stabilize chemical modifications prior to pyrolysis; c) mixing the fluorinated precursor with 1 wt % amorphous boron powder and ball milling the mixture at 400 rpm for 6 hours in a sealed nitrogen-purged jar using zirconia balls; d) loading the milled powder into a high-temperature furnace and performing pyrolysis at 940° C. for 45 minutes in a nitrogen atmosphere, using an iron catalyst supported on alumina spheres; and e) producing boron-doped and fluorine-functionalized CNTs exhibiting p-type conductivity and defect-mediated reactivity, with an average I_D/I_G ratio exceeding 1.2 as verified via Raman spectroscopy.

In this embodiment, the preparation of carbon nanotubes (CNTs) is enhanced by incorporating fluorination and boron doping steps, which modify the chemical and electrical properties of the resulting CNTs. The process begins by exposing the dry egg-derived precursor powder to xenon difluoride (XeF₂) vapor under vacuum conditions of 10⁻⁴ Torr for 2 hours. Xenon difluoride (XeF₂) is used to introduce fluorine atoms into the precursor material, specifically targeting the peptide backbone nitrogen sites. This partial fluorination modifies the electronic properties of the carbon precursor, potentially improving the reactivity and catalytic properties of the resulting CNTs. The vacuum environment ensures that the fluorination is controlled and uniform, preventing any unwanted oxidation or side reactions that could degrade the material.

After the fluorination step, the fluorinated powder is stored in an inert argon environment for at least 12 hours. This storage period allows the chemical modifications to stabilize before the powder undergoes further processing. Storing the powder in an argon atmosphere ensures that no oxidation occurs during this stabilization period and that the fluorine-functionalized precursor remains intact and ready for pyrolysis.

Next, the fluorinated precursor is mixed with 1 wt % amorphous boron powder, which serves to dope the CNTs with boron. The mixture is ball milled at 400 rpm for 6 hours in a sealed nitrogen-purged jar using zirconia balls. Ball milling helps ensure that the amorphous boron powder is uniformly dispersed throughout the precursor material, facilitating efficient doping during the later pyrolysis process. The nitrogen atmosphere is used to prevent any oxidation during the milling process, ensuring that the fluorine and boron modifications are not compromised.

Once the precursor is uniformly mixed, the milled powder is loaded into a high-temperature furnace for pyrolysis. The pyrolysis is conducted at 940° C. for 45 minutes under a nitrogen atmosphere. The nitrogen atmosphere ensures that the process occurs in an oxygen-free environment, preventing the oxidation of the material during the high-temperature treatment. The presence of an iron catalyst, supported on alumina spheres, promotes the formation of CNTs during the pyrolysis process. The catalyst aids in the decomposition of carbon precursors and helps in the nucleation and growth of CNTs. The temperature and atmosphere are optimized to ensure that the boron and fluorine modifications are preserved, while simultaneously promoting the formation of high-quality CNTs.

The final product consists of boron-doped and fluorine-functionalized CNTs, which exhibit p-type conductivity and defect-mediated reactivity. These modifications enhance the electronic properties of the CNTs, making them suitable for applications such as energy storage devices (e.g., batteries, supercapacitors) or sensors, where p-type conductivity and enhanced reactivity are beneficial. The degree of doping and the structural integrity of the CNTs are validated using Raman spectroscopy, which measures the intensity ratio of the D band (defect-related) to the G band (graphitic) in the Raman spectrum. The final CNTs exhibit an average I_D/I_G ratio exceeding 1.2, indicating a higher level of defects and enhanced reactivity, which is typical for materials designed for high-performance applications.

In summary, this embodiment produces boron-doped and fluorine-functionalized CNTs with enhanced electrical and electrochemical properties by incorporating fluorination and boron doping during the precursor preparation. The resulting CNTs exhibit p-type conductivity and defect-mediated reactivity, making them highly suitable for a wide range of advanced technological applications.

In an embodiment, the method 200 further comprises a) supplementing the hydrothermally treated egg precursor with tyrosine and phenylalanine at a combined concentration of 0.4 wt % to enhance aromatic carbon source content; b) adjusting the pH of the solution to 6.9 using sodium carbonate to optimize the protonation state of aromatic residues and promote π-π stacking during thermal treatment; c) drying the modified precursor to a powder form and subjecting it to catalytic pyrolysis at 900° C. under nitrogen with 0.5 wt % iron catalyst co-fed via vaporized ferrocene; d) continuously monitoring the reactor exhaust during pyrolysis using online mass spectrometry to quantify real-time ion intensities of C₂H₂⁺, CO⁺, and NH₃⁺ fragments; and e) dynamically adjusting the furnace heating rate and carrier gas flow using an AI-based closed-loop feedback controller trained to minimize variation in CNT diameters based on detected fragment concentrations and associated kinetic models.

In this embodiment, the synthesis of carbon nanotubes (CNTs) is further refined by enhancing the aromatic carbon source content, optimizing the pyrolysis process, and employing advanced control systems to achieve precise CNT growth. The process begins by supplementing the hydrothermally treated egg-derived precursor with tyrosine and phenylalanine at a combined concentration of 0.4 wt %. These aromatic amino acids are added to enhance the carbon source content, which is essential for the formation of CNTs with higher structural integrity and desirable electrical properties. Tyrosine and phenylalanine are both rich in aromatic rings, which provide a stable foundation for the growth of CNTs and facilitate π-π stacking interactions that improve the quality of the nanotubes.

After supplementation, the pH of the solution is adjusted to 6.9 using sodium carbonate. This pH adjustment is critical for optimizing the protonation state of the aromatic residues in tyrosine and phenylalanine, which enhances the π-π stacking interactions during thermal treatment. By optimizing the protonation state, the solution's properties are tuned to promote the proper formation of aromatic structures that are conducive to CNT growth during subsequent pyrolysis.

The pH adjustment also ensures that the solution remains within a range that prevents unwanted side reactions or degradation during the pyrolysis process.

Once the precursor is modified, it is dried to a powder form to prepare it for pyrolysis. The dried precursor is then subjected to catalytic pyrolysis at 900° C. under nitrogen, with a 0.5 wt % iron catalyst co-fed via vaporized ferrocene. The iron catalyst plays a crucial role in promoting the decomposition of carbon precursors and facilitating the nucleation and growth of CNTs. The nitrogen atmosphere ensures that the pyrolysis process is conducted in an oxygen-free environment, preventing oxidation and ensuring the formation of carbon-rich CNTs.

To achieve precise control over the pyrolysis process and optimize CNT growth, the reactor exhaust is continuously monitored using online mass spectrometry. The mass spectrometer quantifies real-time ion intensities of key fragments such as C₂H₂⁺, CO⁺, and NH₃⁺. These fragments are indicative of the chemical processes occurring within the reactor, including the decomposition of the precursor material and the formation of intermediate species that contribute to CNT growth. By analyzing the ion intensities, the system provides valuable feedback on the reaction dynamics and the progress of the pyrolysis process.

An AI-based closed-loop feedback controller is employed to dynamically adjust the furnace heating rate and carrier gas flow based on the detected fragment concentrations and associated kinetic models. This advanced control system is trained to minimize variation in CNT diameters by adjusting the furnace conditions in real-time, ensuring that the CNTs grow with uniform diameters and consistent structural characteristics. The AI controller uses data from the mass spectrometer to make informed adjustments, optimizing the pyrolysis process to achieve the desired CNT properties. This dynamic control mechanism helps to fine-tune the growth conditions, ensuring that the final CNTs exhibit high quality with minimal defects and variation in size.

In summary, this embodiment employs a sophisticated process that enhances the carbon source content with aromatic amino acids, optimizes the pyrolysis conditions, and integrates real-time monitoring and AI-driven control to produce CNTs with precise diameters and uniform properties. The use of tyrosine and phenylalanine boosts the aromatic carbon content, while advanced control systems ensure that the pyrolysis process is finely tuned to produce high-quality CNTs with tailored structural and electrical properties suitable for applications in energy storage, sensors, and electronics.

In an embodiment, the carbon nanotube nucleation and elongation phase is dynamically modulated using pulse-controlled microwave plasma discharges in a vacuum reactor maintained at 10⁻³ Torr, wherein the plasma is applied at a frequency of 2.45 GHz with pulsing intervals of 100 ms ON and 400 ms OFF over a total duration of 30 minutes to prevent excessive graphitic clustering, wherein an in situ optical emission spectrometer monitors the relative CN*, C₂*, and CH* radical intensities to optimize precursor fragmentation levels, and wherein the elongation directionality is induced by electrostatic field-assisted alignment at ±2 kV/cm to promote the growth of straight, multi-walled CNTs with uniform diameters ranging between 6 to 10 nm.

In this embodiment, the nucleation and elongation phases of carbon nanotube (CNT) growth are carefully controlled and optimized through the use of pulse-controlled microwave plasma discharges, along with real-time monitoring and electrostatic alignment. The process begins with the application of microwave plasma in a vacuum reactor, maintained at 10⁻³ Torr, which provides a controlled environment for CNT synthesis. The plasma is generated at a frequency of 2.45 GHZ, commonly used for microwave plasma generation, and is applied in a pulsed mode with intervals of 100 milliseconds (ms) ON and 400 ms OFF. The pulsing intervals are critical for modulating the energy input into the system, allowing for more precise control over the nucleation and elongation of the CNTs. The ON phase provides sufficient energy to break down the precursor material and initiate the formation of carbon species, while the OFF phase allows the system to cool, preventing excessive graphitic clustering that can result in undesirable CNT growth. The total duration of this process is 30 minutes, providing enough time for the CNTs to form with optimal characteristics.

An in situ optical emission spectrometer is used to monitor the relative intensities of specific radicals such as CN*, C₂*, and CH*. These radicals are indicators of the plasma environment and the chemical reactions occurring during the synthesis process. By analyzing the relative intensities of these species in real-time, the system can optimize the precursor fragmentation levels, ensuring that the right amount of carbon and nitrogen species are available for CNT growth. The spectrometer allows for continuous feedback on the plasma conditions, which is crucial for maintaining a stable and controlled environment conducive to high-quality CNT formation.

The elongation of the CNTs is further controlled through the application of an electrostatic field-assisted alignment technique. An electrostatic field of ±2 kV/cm is applied during the growth process to induce the directional alignment of the growing CNTs. This electrostatic field promotes the formation of straight, multi-walled CNTs with uniform diameters, ranging between 6 to 10 nm. The electrostatic field ensures that the CNTs grow in a uniform and controlled direction, which is critical for achieving high-performance CNTs suitable for applications in electronics, energy storage, and sensors, where alignment and uniformity are important for optimizing electrical and mechanical properties.

By combining pulse-controlled microwave plasma discharges with real-time monitoring and electrostatic field-assisted alignment, this process allows for the dynamic modulation of the CNT nucleation and elongation phases, resulting in high-quality CNTs with uniform diameters, controlled morphology, and optimized properties for various advanced technological applications.

In an embodiment, prior to pyrolysis, the blended egg yolk and egg white powders are subjected to chemical pre-activation using a 1 M potassium hydroxide (KOH) solution under continuous magnetic stirring at 300 rpm for 2 hours at 60° C., wherein the wet mass is then filtered and vacuum dried at 80° C. for 6 hours, wherein the KOH pre-treatment induces porosity and edge site exposure in the carbon matrix, increasing the specific surface area to at least 400 m²/g, and wherein the resultant porous mass is impregnated with 2 wt % cobalt nitrate, followed by air drying and low-temperature calcination at 300° C. for 1 hour to form catalytic Co₃O₄ clusters prior to high-temperature CNT growth; wherein the CNT synthesis is carried out in a fluidized bed reactor using inert zirconia beads of 100 μm diameter to promote uniform thermal contact and minimize local hot spots, wherein the temperature profile is dynamically adjusted using a PID-controlled segmented heating coil such that the axial temperature gradient does not exceed 15° C. across any 5 cm segment, wherein a pre-mixed gas stream of acetylene and ammonia in a 3:1 ratio is fed into the chamber at a flow rate of 80 sccm; and

In this embodiment, a detailed chemical pre-activation and CNT synthesis process is employed to enhance the porosity, catalytic activity, and structural characteristics of the carbon nanotubes (CNTs). The process begins with the chemical pre-activation of the blended egg yolk and egg white powders using a 1 M potassium hydroxide (KOH) solution. The solution is mixed under continuous magnetic stirring at 300 rpm for 2 hours at 60° C., which facilitates the breaking of chemical bonds and promotes the formation of porosity within the carbon matrix. The KOH treatment is critical for increasing the specific surface area of the precursor material, which is a key factor in enhancing the catalytic properties during the CNT synthesis. By exposing edge sites and creating pores, the KOH pre-treatment increases the specific surface area of the material to at least 400 m²/g, making it more reactive and suitable for CNT growth.

After the pre-activation step, the wet mass is filtered to remove any excess solution, and the material is vacuum dried at 80° C. for 6 hours. This drying step ensures that the KOH-treated material is free from moisture and ready for the subsequent impregnation with cobalt nitrate. The impregnation of the pre-activated material with 2 wt % cobalt nitrate introduces cobalt ions, which will serve as catalysts during the high-temperature CNT growth process. Following the impregnation, the material is air-dried and subjected to low-temperature calcination at 300° C. for 1 hour. The calcination process decomposes the cobalt nitrate, converting it into cobalt oxide (Co₃O₄) clusters, which are critical for facilitating the nucleation and growth of CNTs during the pyrolysis stage.

The CNT synthesis itself is carried out in a fluidized bed reactor, where inert zirconia beads of 100 μm diameter are used to promote uniform thermal contact between the precursor material and the heat source, while minimizing the formation of local hot spots. The use of zirconia beads ensures that the material is evenly heated throughout the reactor, which is crucial for achieving consistent and controlled CNT growth. The reactor is equipped with a PID-controlled segmented heating coil that dynamically adjusts the temperature profile. This system ensures that the axial temperature gradient does not exceed 15° C. across any 5 cm segment of the reactor, allowing for precise temperature control during the high-temperature synthesis process. Maintaining uniform temperature conditions is essential for ensuring that the CNTs grow with the desired structural properties, such as uniform diameter and length.

To facilitate the decomposition of the carbon precursor and promote CNT growth, a pre-mixed gas stream consisting of acetylene and ammonia in a 3:1 ratio is fed into the chamber at a flow rate of 80 sccm. Acetylene serves as the carbon source, while ammonia provides the necessary nitrogen to dope the CNTs and modify their electronic properties. The ammonia also helps to maintain a reducing atmosphere, preventing oxidation during the high-temperature process and promoting the formation of CNTs with the desired structure and properties.

The combination of the chemical pre-activation, cobalt catalysis, fluidized bed reactor setup, and precise temperature and gas flow control ensures that the resulting CNTs have high quality and consistency. The use of cobalt oxide clusters as catalysts promotes efficient CNT nucleation and growth, while the uniform heating and gas flow conditions ensure that the CNTs have uniform diameters and optimized properties for applications in energy storage, electronics, and other advanced technologies.

In an embodiment, the thermal decomposition step is preceded by a controlled Maillard reaction stage between proteinaccous and lipid fractions of the egg-derived precursor, wherein said Maillard reaction is induced by maintaining the blend at a temperature of 130° C.±2° C. under a low oxygen environment (≤1% O₂ by volume) for a duration of 2 hours, wherein this reaction leads to the formation of intermediate heterocyclic compounds and nitrogenous polymers that act as internal carbon-nitrogen dopant sources during pyrolysis, wherein the extent of the Maillard reaction is monitored via real-time Fourier-transform infrared spectroscopy (FTIR) using absorption peaks at 1540 cm⁻¹ and 1635 cm⁻¹ indicative of imidazole ring and Schiff base formation, respectively, and wherein the intensity ratio of these peaks is adjusted by varying precursor pH within a controlled range of 6.8 to 8.1 to tune nitrogen doping profiles in the resulting CNT structure.

In this embodiment, the synthesis of carbon nanotubes (CNTs) is enhanced by a controlled Maillard reaction stage, which plays a crucial role in introducing nitrogen doping into the final CNT product. The Maillard reaction is a thermochemical reaction between the proteinaceous and lipid fractions of the egg-derived precursor material. This reaction is carefully controlled to ensure the formation of intermediate heterocyclic compounds and nitrogenous polymers, which act as carbon-nitrogen dopant sources during the subsequent pyrolysis stage.

To initiate the Maillard reaction, the precursor blend is maintained at a temperature of 130° C.±2° C. under a low-oxygen environment, where the oxygen concentration is kept at or below 1% by volume. This controlled atmosphere is essential for preventing oxidation and ensuring that the Maillard reaction proceeds under reducing conditions. The temperature and low-oxygen conditions are optimized to promote the formation of the desired heterocyclic and nitrogenous intermediates without causing unwanted degradation of the precursor material. The reaction is allowed to proceed for 2 hours, providing enough time for the nitrogenous polymers to form, which will later serve as dopants in the CNTs.

The extent of the Maillard reaction is closely monitored in real-time using Fourier-transform infrared spectroscopy (FTIR). FTIR is used to track the formation of key absorption peaks that are indicative of the reaction's progress. Specifically, absorption peaks at 1540 cm⁻¹ and 1635 cm⁻¹ correspond to the formation of imidazole rings and Schiff bases, respectively. These chemical structures are critical for introducing nitrogen into the CNTs during pyrolysis. The presence of these peaks confirms that the Maillard reaction is proceeding as intended and that the desired intermediates are being formed.

To fine-tune the nitrogen doping profile in the resulting CNT structure, the intensity ratio of the imidazole ring and Schiff base peaks (I₁₅₄₀/I₁₆₃₅) is adjusted by varying the precursor pH within a controlled range of 6.8 to 8.1. This pH adjustment allows for precise control over the nitrogen doping levels, which can significantly influence the electronic and electrochemical properties of the resulting CNTs. By optimizing the nitrogen content, the Maillard reaction ensures that the CNTs will have improved conductivity, electrochemical stability, and reactivity, making them suitable for advanced applications in energy storage, sensors, and catalysis.

After the Maillard reaction is complete and the desired nitrogenous intermediates are formed, the precursor material is subjected to pyrolysis. During pyrolysis, the nitrogenous polymers act as dopants, incorporating nitrogen into the carbon nanotube structure, which enhances the performance of the CNTs. The resulting CNTs have controlled nitrogen doping profiles, which contribute to their improved conductivity and reactivity for various technological applications.

In summary, this embodiment integrates the Maillard reaction to introduce nitrogen into the CNT structure, allowing for precise control over the doping levels, and enhancing the CNTs' properties for high-performance applications. The use of real-time FTIR monitoring, pH control, and low-oxygen conditions during the reaction ensures that the process is highly controlled, leading to the formation of CNTs with tailored nitrogen doping for optimized performance.

In an embodiment, a dual-function bimetallic catalyst system comprising iron (Fc) and molybdenum (Mo) nanoparticles is synthesized in situ by decomposing ferric acetylacetonate and ammonium molybdate in a 1:0.8 molar ratio, wherein the catalytic particles are deposited via aerosol-assisted chemical vapor deposition (AACVD) by atomizing a methanolic suspension of the two precursors at a flow rate of 0.2 mL/min, wherein this catalyst system enables both tip-growth and base-growth mechanisms within the same reactor zone, wherein the segregation of growth modes is driven by differential thermal gradients of 5° C./cm along the reactor axis and by varying local carbon feed concentrations via pulsed acetylene injection at 15-second intervals, and wherein this leads to a mixed population of CNTs with aspect ratios ranging from 10³ to 10⁵ and spatial orientation anisotropy measurable by polarized SEM imaging, and wherein the pyrolysis temperature ramping is executed in a non-linear segmented profile comprising: (i) an initial slow ramp from ambient to 400° C. at 2° C./min to facilitate gradual protein carbonization, (ii) a rapid ramp from 400° C. to 800° C. at 10° C./min for vapor-phase transformation, and (iii) a final hold at 850° C. for 45 minutes to allow for tubular crystallization, wherein during the rapid ramp phase, argon is introduced at 80 sccm along with a temporary 5-minute spike of isopropanol vapor to act as a secondary carbon enhancer and hydroxyl radical scavenger, wherein the hold period is dynamically extended up to 60 minutes if in situ laser Raman measurements reveal a D/G intensity ratio greater than 1.5, and wherein feedback control for this adjustment is executed through a closed-loop system that integrates thermogravimetric analysis (TGA) data with real-time Raman spectral input.

In this embodiment, a dual-function bimetallic catalyst system comprising iron (Fc) and molybdenum (Mo) nanoparticles is synthesized in situ to enable controlled growth of carbon nanotubes (CNTs) via both tip-growth and base-growth mechanisms within the same reactor zone. This catalyst system is designed to offer versatility in CNT synthesis by enabling different growth modes depending on the reactor conditions.

The Fe—Mo catalyst system is prepared by decomposing ferric acetylacetonate and ammonium molybdate in a 1:0.8 molar ratio, which provides the necessary iron and molybdenum species for catalyzing CNT growth. These catalytic particles are deposited onto a substrate via aerosol-assisted chemical vapor deposition (AACVD), where a methanolic suspension of the precursors is atomized at a flow rate of 0.2 mL/min. The aerosolized particles are then introduced into the reactor, where they deposit onto the substrate and facilitate CNT formation. The use of AACVD enables fine control over the deposition process, ensuring that the catalyst particles are uniformly distributed and effectively promoted for CNT growth.

The catalyst system allows for both tip-growth and base-growth mechanisms, depending on local conditions within the reactor. The differential thermal gradients along the reactor axis play a significant role in controlling the growth mode. A gradient of 5° C./cm is maintained to drive the segregation of growth modes, allowing for CNTs to grow from either the tip or the base. Additionally, local carbon feed concentrations are varied through pulsed acetylene injection, which occurs at 15-second intervals. This pulsed injection introduces controlled amounts of carbon into the system, further modulating the growth mechanism and enabling the formation of CNTs with diverse characteristics.

As a result of these controlled growth conditions, the CNTs exhibit a mixed population with aspect ratios ranging from 10³ to 10⁵, reflecting both tip-growth and base-growth CNTs. Their spatial orientation anisotropy, which is the directional alignment of the CNTs, is measurable through polarized scanning electron microscopy (SEM), providing insight into the growth behavior and structural properties of the CNTs.

The pyrolysis step is carefully designed to optimize the CNT growth process. The temperature ramping is executed in a non-linear segmented profile to ensure precise control over the carbonization and crystallization stages. The process begins with a slow ramp from ambient to 400° C. at 2° C./min, which allows for gradual carbonization of the precursor material, ensuring that the carbon matrix is stabilized before the high-temperature transformation begins. Next, the temperature is rapidly increased from 400° C. to 800° C. at 10° C./min, enabling vapor-phase transformation of the carbon source and promoting the initial stages of CNT growth. Finally, the temperature is held at 850° C. for 45 minutes to allow for the tubular crystallization of the CNTs, ensuring that they achieve the desired structural quality.

During the rapid ramp phase, argon is introduced at a flow rate of 80 sccm to maintain an inert atmosphere and prevent oxidation. Additionally, a 5-minute spike of isopropanol vapor is introduced to act as a secondary carbon enhancer and a hydroxyl radical scavenger, further promoting the formation of high-quality CNTs. The presence of isopropanol helps to suppress unwanted side reactions, ensuring that the CNTs grow with minimal defects.

The hold period at 850° C. is dynamically adjusted based on real-time feedback from in situ laser Raman spectroscopy measurements. If the D/G intensity ratio exceeds 1.5, indicating that the CNTs are not fully graphitized, the hold time is extended up to 60 minutes. This dynamic adjustment ensures that the CNTs achieve the desired crystallinity and structural quality. Feedback control is managed through a closed-loop system that integrates thermogravimetric analysis (TGA) data with real-time Raman spectral input, allowing for continuous monitoring and optimization of the pyrolysis process.

This advanced control system ensures that the CNTs are synthesized with precise structural characteristics, including uniform diameters, controlled growth modes, and enhanced crystallinity, making them ideal for applications in energy storage, sensors, electronics, and other high-performance technologies.

In an embodiment, the egg-derived precursor blend is modified with a chelating agent selected from the group consisting of ethylenediaminetetraacetic acid (EDTA), citric acid, or phytic acid at a concentration of 0.1-0.3 M, wherein the chelating agent is added to pre-complex the calcium, magnesium, and iron ions inherently present in the egg matrix, wherein such chelation modulates the catalytic nucleation points by controlling metal aggregation behavior under heat, wherein this leads to the formation of CNTs with narrow inner diameters between 1.5 to 3 nm, and wherein the wall number is limited to 2-3 layers as validated via high-resolution transmission electron microscopy (HR-TEM), with inter-wall spacing in the range of 0.34 to 0.36 nm, wherein post-synthesis surface modification of the CNTs is carried out by immersing the pyrolytically grown material in a 1:1 v/v solution of nitric acid and sulfuric acid at 60° C. for 4 hours under continuous sonication at 40 kHz, wherein the acid treatment introduces —COOH and —OH functional groups onto the CNT sidewalls, thereby enhancing hydrophilicity and dispersibility in aqueous media, wherein the functionalized CNTs are filtered, washed to PH neutral, and further reacted with (3-aminopropyl)triethoxysilane (APTES) in toluene at 80° C. for 2 hours to introduce terminal amine groups; and wherein prior to pyrolysis, the precursor blend is suspended in a 3 wt % aqueous gelatin solution at 40° C. for 15 minutes to form a viscoelastic hydrogel matrix, wherein this hydrogel is subjected to directional freeze-casting by immersion in a liquid nitrogen-cooled copper plate, resulting in vertically aligned ice-crystal templating, wherein freeze-dried samples retain the Templated porosity, which guides the vertical orientation of CNT growth during thermal decomposition due to capillary-induced alignment effects.

In this embodiment, the synthesis of carbon nanotubes (CNTs) is enhanced through several intricate processes aimed at controlling the structure and properties of the final CNT product. The process begins with modifying the egg-derived precursor blend using a chelating agent selected from ethylenediaminetetraacetic acid (EDTA), citric acid, or phytic acid, at a concentration of 0.1-0.3 M. The chelating agent is introduced to pre-complex the calcium, magnesium, and iron ions that are inherently present in the egg matrix. This chelation is crucial for modulating the catalytic nucleation points during CNT formation by controlling metal aggregation behavior under heat. The chelation process ensures that metal ions are evenly distributed and well-activated, preventing the formation of larger metal aggregates that could lead to inconsistent CNT growth. As a result, this process helps form CNTs with narrow inner diameters ranging from 1.5 to 3 nm, with the wall number limited to 2-3 layers, which is desirable for high-performance applications such as energy storage, catalysis, and electronics.

High-resolution transmission electron microscopy (HR-TEM) is used to validate the structural characteristics of the CNTs, confirming the narrow inner diameters and the limited wall number. Additionally, the inter-wall spacing is measured to be within the range of 0.34 to 0.36 nm, indicating the high-quality and well-structured CNTs produced by this method.

Once the CNTs are synthesized, post-synthesis surface modification is carried out to improve their functional properties. The pyrolytically grown CNTs are immersed in a 1:1 v/v solution of nitric acid and sulfuric acid at 60° C. for 4 hours, under continuous sonication at 40 kHz. This acid treatment introduces —COOH (carboxyl) and —OH (hydroxyl) functional groups onto the sidewalls of the CNTs, which significantly enhances their hydrophilicity and dispersibility in aqueous media. These functional groups are important for improving the CNTs' interactions with various matrices or solvents, making them more versatile for use in composite materials or as catalysts in liquid-phase reactions. The functionalized CNTs are then filtered, washed to neutral pH, and further reacted with (3-aminopropyl)triethoxysilane (APTES) in toluene at 80° C. for 2 hours. This reaction introduces terminal amine groups onto the CNT sidewalls, further enhancing the CNTs' reactivity and allowing them to be functionalized for specific applications, such as in sensors or drug delivery systems.

Prior to pyrolysis, the precursor blend is suspended in a 3 wt % aqueous gelatin solution at 40° C. for 15 minutes to form a viscoelastic hydrogel matrix. This hydrogel matrix is crucial for controlling the orientation of the CNTs during the subsequent synthesis process. The hydrogel is subjected to directional freeze-casting by immersing it in a liquid nitrogen-cooled copper plate, which leads to the formation of vertically aligned ice crystals. This ice-crystal templating results in the creation of aligned pores in the hydrogel. The freeze-dried samples retain this templated porosity, which serves to guide the vertical orientation of CNT growth during thermal decomposition. The capillary-induced alignment effects from the freeze-casting process ensure that the CNTs grow in a vertical direction, leading to the formation of well-aligned CNTs that exhibit enhanced structural properties, such as increased mechanical strength and conductivity.

In an embodiment, the egg-derived precursor is supplemented with 0.2 to 0.5 wt % of graphene oxide flakes dispersed in deionized water and sonicated for 30 minutes prior to drying, wherein the graphene oxide serves as a 2D nucleation scaffold that facilitates π-π stacking with aromatic residues formed during the decomposition of tyrosine and phenylalanine in egg proteins, wherein the CNTs grow as coaxial shells around the graphene oxide domains during thermal processing at 800° C., wherein the composite structure is characterized by a hybrid tubular-platelet morphology with enhanced electron mobility (>10⁴ S/m) due to synergistic edge conduction pathways, and wherein a continuous real-time mass spectrometric monitoring system is integrated with the pyrolysis chamber via a quartz sampling line and ion trap detector, wherein molecular fragments such as C₂H₂⁺, NH₃⁺, and CO⁺ are tracked to infer carbon-nitrogen rearrangement kinetics during pyrolytic decomposition.

In this embodiment, the egg-derived precursor is enhanced by the addition of graphene oxide (GO) flakes, which play a crucial role in directing the formation of carbon nanotubes (CNTs) with enhanced electronic properties. The precursor blend is supplemented with 0.2 to 0.5 wt % of graphene oxide flakes, which are dispersed in deionized water and sonicated for 30 minutes to ensure a homogeneous dispersion. The graphene oxide flakes act as a two-dimensional (2D) nucleation scaffold, facilitating the growth of CNTs by promoting π-π stacking interactions with aromatic residues that form during the decomposition of amino acids like tyrosine and phenylalanine in the egg proteins. The aromatic residues are critical for the CNT formation, and their interaction with the graphene oxide provides a stable foundation for the development of the carbon nanotube structure.

During the thermal processing at 800° C., the CNTs grow as coaxial shells around the graphene oxide domains. This results in a composite structure where the CNTs are encapsulated by graphene oxide, creating a hybrid tubular-platelet morphology. The coaxial shell structure enhances the conductivity and electrochemical properties of the CNTs. The presence of graphene oxide contributes significantly to the material's electron mobility, which exceeds 104 S/m. This is due to the synergistic edge conduction pathways formed between the graphene oxide and the CNTs, enhancing the material's electrical conductivity and making it suitable for high-performance applications such as energy storage, electronics, and sensors.

To ensure optimal CNT growth and structural quality, the pyrolysis process is closely monitored. A continuous real-time mass spectrometric monitoring system is integrated with the pyrolysis chamber via a quartz sampling line and an ion trap detector. This system tracks molecular fragments such as C₂H₂⁺ (acetylene ion), NH₃⁺ (ammonia ion), and CO⁺ (carbon monoxide ion) to infer the carbon-nitrogen rearrangement kinetics during pyrolytic decomposition. These fragments provide valuable information about the progress of the pyrolysis process, allowing for real-time adjustments and optimization of the conditions to achieve the desired CNT structure. By monitoring these molecular species, the system ensures that the carbon-nitrogen chemistry is properly controlled, preventing the formation of undesired by-products and ensuring that the CNTs are grown with the correct morphology and doping.

In an embodiment, the precursor powder is electrostatically sprayed onto a rotating ceramic drum pre-heated to 250° C. to induce partial carbonization prior to final pyrolysis, wherein the spraying is done using a high-voltage DC field of 15-18 kV, producing droplets with mean diameters below 10 μm, wherein the resulting shell-core microspheres undergo controlled thermal cracking during ramp-up heating, wherein this yields a hierarchically porous CNT network with dual-modal pore distribution (micropores<2 nm and mesopores 5-10 nm), and wherein the BET surface area is enhanced to >800 m²/g without the use of external templates or pore formers, and wherein a metal-organic framework (MOF) precursor, selected from ZIF-67 or MIL-101, is introduced at 3-6 wt % into the egg powder matrix during blending, wherein the MOF acts as both a secondary catalyst precursor and as a sacrificial structure for porosity modulation, wherein the MOF decomposes during pyrolysis to yield in situ cobalt or iron nanoparticles embedded within graphitized carbon shells, wherein the growth of CNTs proceeds radially outward from these embedded metal sites, producing flower-like multi-branched CNT clusters.

In this embodiment, a highly controlled process is employed to synthesize carbon nanotubes (CNTs) with a hierarchically porous network and enhanced surface area, utilizing electrostatic spraying, metal-organic frameworks (MOFs), and pyrolysis. The precursor powder, derived from egg components, is electrostatically sprayed onto a rotating ceramic drum pre-heated to 250° C. This process induces partial carbonization of the precursor material before the final pyrolysis stage. The spraying is carried out using a high-voltage DC field ranging from 15 to 18 kV, which atomizes the precursor into droplets with mean diameters below 10 μm. The fine droplets ensure that the precursor material is uniformly distributed and that the carbonization process can occur evenly across the surface.

As the precursor droplets are deposited onto the ceramic drum, the resulting shell-core microspheres undergo controlled thermal cracking during ramp-up heating. This thermal cracking process helps to create a CNT network with a dual-modal pore distribution, consisting of micropores (<2 nm) and mesopores (5-10 nm). The hierarchical porosity is essential for increasing the surface area and improving the adsorption capacity of the final CNTs, which are particularly beneficial for applications like energy storage and catalysis. The BET surface area of the material is enhanced to greater than 800 m²/g, which is achieved without the use of external templates or pore formers. This is a significant advantage, as it simplifies the synthesis process while still achieving high surface area and desirable porosity.

Additionally, a metal-organic framework (MOF) precursor, selected from ZIF-67 or MIL-101, is introduced at a concentration of 3-6 wt % during the blending of the egg-derived precursor powder. The MOF serves two key purposes: it acts as a secondary catalyst precursor, which helps in the formation of metal nanoparticles during pyrolysis, and it also functions as a sacrificial structure that modulates porosity. The MOF particles are strategically chosen for their ability to generate well-dispersed metal sites (such as cobalt or iron) upon thermal decomposition. During the pyrolysis stage, the MOF decomposes, releasing the metal nanoparticles that are embedded within graphitized carbon shells. These metal nanoparticles play a crucial role in catalyzing the growth of CNTs.

The growth of CNTs proceeds radially outward from the embedded metal sites, forming flower-like multi-branched CNT clusters. The metal nanoparticles act as nucleation sites, promoting the growth of CNTs in multiple directions, resulting in the formation of multi-branched structures that enhance the material's surface area and conductivity. The flower-like morphology of the CNTs is highly desirable in applications such as energy storage (e.g., supercapacitors or batteries) and catalysis, where high surface area and efficient charge transport are key factors for performance.

This synthesis method enables the production of CNTs with enhanced surface area, well-controlled porosity, and a flower-like structure, all while utilizing a simple and efficient process that combines electrostatic spraying, MOF templating, and thermal decomposition. The resulting CNTs are ideal for a variety of advanced applications, offering both high performance and versatility.

In an embodiment, the surface energy of the precursor powder is modified through fluorination by exposing the powder to xenon difluoride (XeF₂) vapor under vacuum (10⁻⁴ Torr) for 2 hours, wherein this causes partial fluorination of peptide backbone sites, reducing the decomposition onset temperature by up to 50° C.; and wherein the pyrolysis process is preceded by mechanochemical activation via high-energy ball milling of the egg-based precursor with 1 wt % amorphous boron for 6 hours at 400 rpm in a nitrogen atmosphere, wherein this step induces localized plastic deformation and bond rupture leading to increased chemical reactivity, wherein the boron acts as both a structural defect promoter and a mild catalyst dopant, resulting in p-type doping of the CNTs.

In this embodiment, the synthesis of carbon nanotubes (CNTs) is enhanced through surface energy modification and mechanochemical activation of the egg-derived precursor powder, leading to improved reactivity and targeted doping of the CNTs. The process begins with the fluorination of the precursor powder by exposing it to xenon difluoride (XeF₂) vapor under vacuum conditions at 10⁻⁴ Torr for 2 hours. The exposure to XeF₂ induces partial fluorination of the peptide backbone sites in the precursor material, which has a significant effect on the material's properties. The fluorine atoms modify the surface energy of the precursor, reducing its decomposition onset temperature by up to 50° C. This reduction in temperature makes the precursor more reactive during subsequent thermal processing, thus enabling more efficient carbonization and CNT growth.

After fluorination, the precursor powder undergoes mechanochemical activation via high-energy ball milling. The powder is mixed with 1 wt % amorphous boron and ball milled for 6 hours at 400 rpm in a nitrogen atmosphere. The milling process induces localized plastic deformation and bond rupture within the precursor material, significantly increasing its chemical reactivity. The mechanical forces exerted during the ball milling break down the precursor's molecular structure, facilitating more efficient decomposition and carbonization during the later stages of the process. This step also enhances the distribution of amorphous boron within the precursor, which plays two key roles: it acts as a structural defect promoter, increasing the number of active sites for CNT growth, and serves as a mild catalyst dopant that influences the growth of CNTs during pyrolysis. The boron doping results in p-type doping of the CNTs, which modifies their electronic properties, making them more suitable for applications in devices requiring p-type conductivity, such as certain types of transistors and sensors.

The current method presents an innovative method for producing high-quality CNTs from eggs by employing both egg white and egg yolk as carbon sources. The synthesis approach entails a bifurcated procedure:
Precursor Preparation: The initial stage is extracting and processing egg white and yolk to isolate their organic constituents. This can be achieved by dehydrating and grinding the egg whites and yolk into a fine powder or by employing a hydrothermal treatment to decompose the organic contents into a solution.
Catalytic Pyrolysis: The subsequent stage is pyrolyzing the egg-derived precursor in a regulated environment with Fe catalyst that facilitates the synthesis of CNTs. Pyrolysis is conducted at temperatures between 600° C. and 1000° C. in an inert gas atmosphere to prevent oxidation and facilitate carbon deposition. The metallic catalyst promotes the nucleation of CNTs on its surface, while the organic constituents of the egg-derived precursor decompose, resulting in carbon structures that self-assembled into CNTs.

### Step 1: Egg-Derived Precursor Preparation

Egg White (Albumin): The egg whites possess a significant concentration of proteins, chiefly albumin, which creates a nitrogen-rich milieu advantageous for nitrogen-doped carbon nanotubes. The egg whites are segregated from the yolk, and the proteins are obtained using drying or hydrolysis techniques. The resultant protein powder is subsequently milled into a fine consistency.
Egg Yolk (Lipids): Egg yolk has lipids and cholesterol, which can serve as supplementary carbon sources during pyrolysis. The yolk is isolated and desiccated, thereafter transformed into a powder or paste.
Blended Precursor: A combination of egg white and yolk powder can be manufactured in a specified ratio to regulate the nitrogen/carbon content in the resultant CNTs. The combination undergoes a pre-treatment process of low-temperature carbonisation (via hydrothermal) to decompose the organic constituents and ready them for pyrolysis.

### Step 2: Catalytic Pyrolysis

Catalyst Selection: Iron (Fe) was utilised to facilitate the synthesis of CNTs. The catalyst is either infused into the precursor material or applied onto a support material (e.g., alumina, silica) to promote the formation of CNTs.
Pyrolysis Conditions: The precursor material is subjected to heating in a tube furnace or a fluidised bed reactor under Ar gas to avert oxidation. The heating process occurs at temperatures between 900° C. and 1000° C., contingent upon the desired features of the CNTs. The carbonisation process may extend over many hours to guarantee the thorough conversion of the precursor into CNTs.
Gas Flow and Temperature Control: A regulated gas flow system guarantees the preservation of an inert atmosphere during the pyrolysis process. The gas flow rate is calibrated to ensure uniform heating and consistent carbon deposition on the catalyst.

### Step 3: Post-Synthesis Treatment

Purification: The synthesised CNTs are isolated from catalyst particles and unreacted carbon by-products using acid washing or centrifugation. This purification method eliminates all remaining organic substances and metal catalyst residues.
Characterization and Functionalization: The CNTs were further characterised using techniques such as scanning electron microscopy (SEM), transmission electron microscopy (TEM), and X-ray diffraction (XRD).

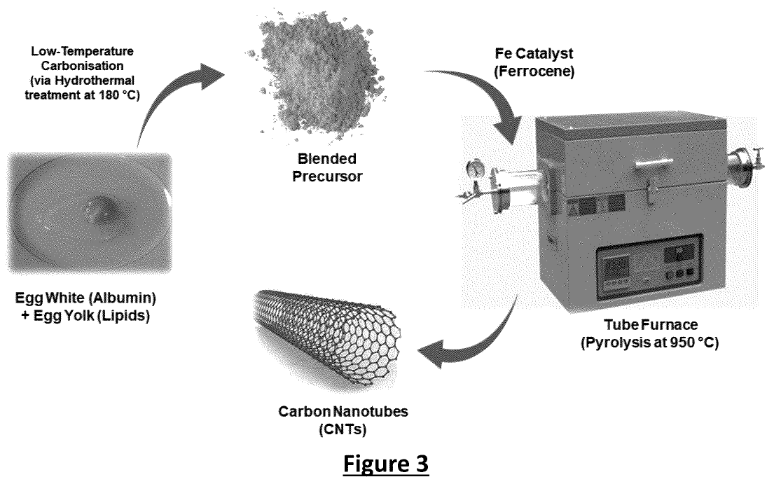

FIG. 3 illustrates a methodical synthesis of egg-derived CNTs in accordance with an embodiment of the present disclosure. This method encompasses standard hydrothermal and pyrolysis treatments, which are essential steps for producing high-quality carbon nanotubes from egg-derived precursors. The egg white and egg yolk, abundant in carbon, are subjected to hydrothermal treatment with a catalyst (Ferrocene) to facilitate the development of carbon-rich structures. The precursor material undergoes pyrolysis at high temperatures, leading to the decomposition of organic components and the formation of CNTs. This approach uses a waste material sustainably while generating carbon nanotubes with superior structural integrity and electrical characteristics. The integration of hydrothermal and pyrolytic treatments is essential for regulating the dimensions, shape, and orientation of CNTs, rendering them appropriate for diverse applications, including energy storage, sensors, and advanced composite materials.

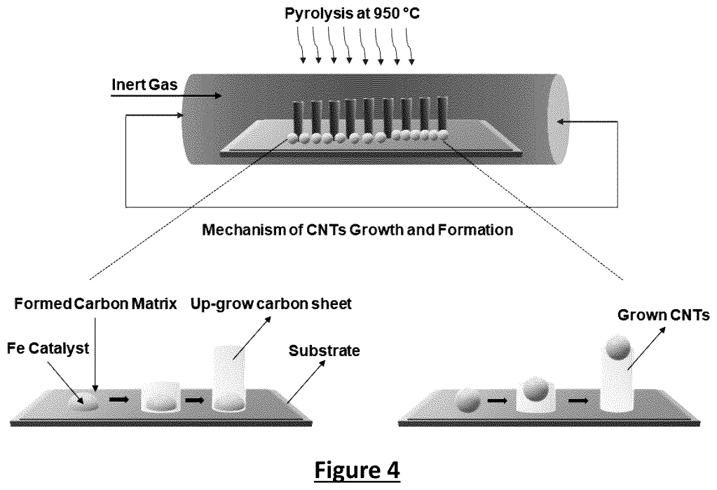

FIG. 4 illustrates a typical mechanism of CNTs formation during pyrolysis, emphasising the roles of both egg-derived white and yolk components in the presence of a ferrocene catalyst in accordance with an embodiment of the present disclosure. The process starts with the heat degradation of the organic contents in the egg shell, including the proteins and lipids found in the egg white and yolk, which serve as carbon sources. In the presence of ferrocene, a catalyst known to promote CNT synthesis, these organic precursors disintegrate at high temperatures, often between 900° C. and 1000° C. The ferrocene catalyst promotes the breakdown of carbon-rich substances, resulting in the nucleation and development of CNTs from carbon atoms liberated during pyrolysis. The egg white, which is high in proteins and water, provides a supply of volatile carbon species that help to build the CNT walls, whereas the yolk, which contains lipids and fatty acids, helps to improve the structure and quality of the CNTs. The exact interaction of these egg-derived components with the catalyst determines the CNTs' shape, alignment, and overall yield. This technique not only reveals the adaptability of egg-based precursors for CNT formation, but also highlights the significance of the catalytic environment in determining the final characteristics of the synthesised CNTs.

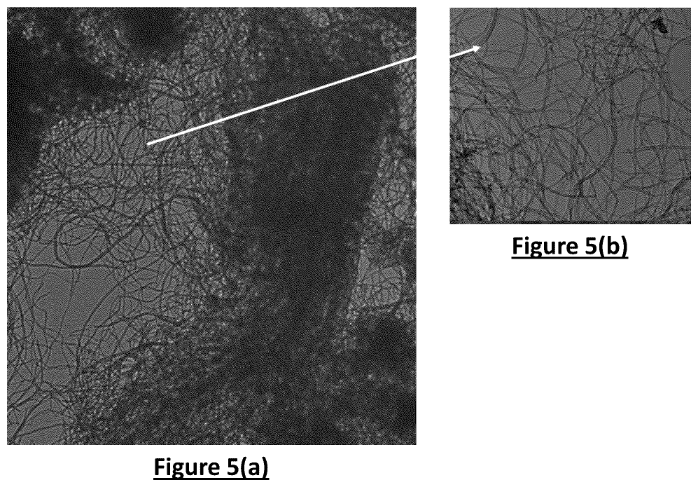

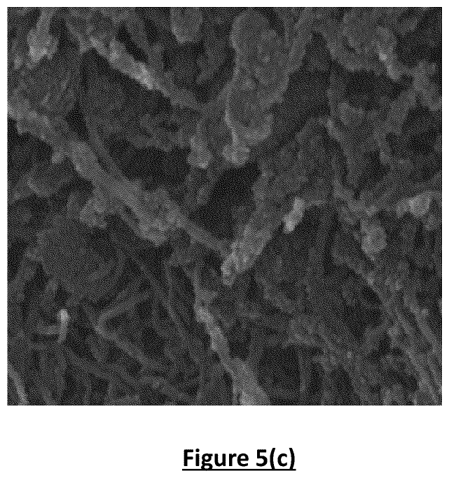

FIG. 5 illustrates typical transmission electron microscopy (TEM) and scanning electron microscopy (SEM) pictures of the manufactured carbon nanotubes (CNTs), demonstrating the creation of well-structured CNTs in accordance with an embodiment of the present disclosure.

FIG. 5 depict typical transmission electron microscopy (TEM) and scanning electron microscopy (SEM) pictures of the manufactured carbon nanotubes (CNTs), demonstrating the creation of well-structured CNTs. The TEM pictures in FIG. 5(a-b) show the interior structure of the CNTs, which have a smooth, cylindrical morphology that is typical of high-quality carbon nanotubes. The high-resolution TEM image shows the well-aligned graphitic layers that make up the core of the nanotubes, emphasising the CNTs' outstanding crystalline structure. Meanwhile, FIG. 5(c) shows a more comprehensive perspective of the CNTs' exterior morphology, including their uniform distribution and straight, elongated morphologies. The SEM analysis also reveals the presence of isolated nanotubes with low agglomeration, indicating a high level of purity and regulated development throughout synthesis.

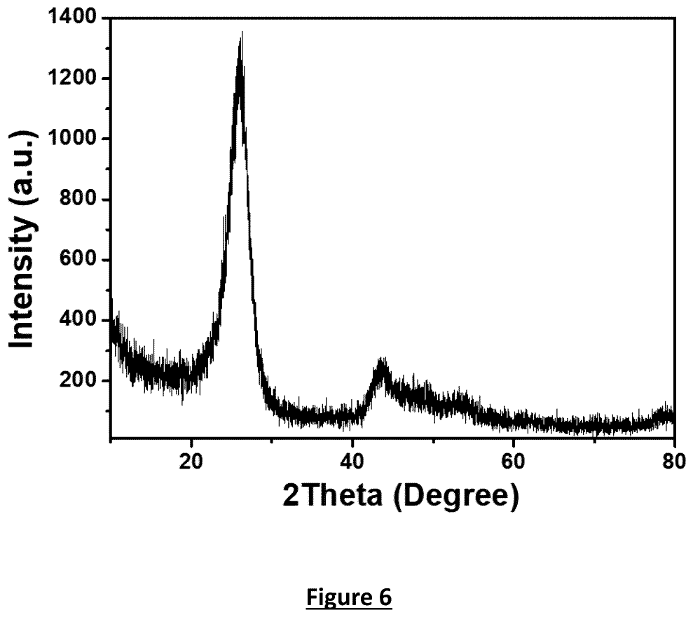

FIG. 6 illustrates an X-ray diffraction (XRD) pattern of the prepared CNTs in accordance with an embodiment of the present disclosure. FIG. 6 showed the X-ray diffraction (XRD) pattern of the prepared CNTs. The XRD pattern of egg-derived CNTs often exhibits distinctive peaks corresponding to the crystalline structure of graphite, the essential building block of CNTs. The peak at 26° (2θ) corresponds to the (002) plane of graphite, indicating the presence of graphitic carbon in nanotubes. This peak represents the highly organised carbon atoms grouped in a hexagonal lattice, which is a hallmark of CNTs' graphitic properties. In addition to the (002) peak, the XRD pattern may exhibit a peak about 43.4° (2θ), which corresponds to the (101) diffraction plane of graphitic carbon. The presence of these peaks implies that the synthesised CNTs have a high level of crystallinity, which is required for mechanical strength, electrical conductivity, and other desired features. The sharpness of these peaks indicates that the CNTs are well-organised, with few flaws in the graphite lattice.

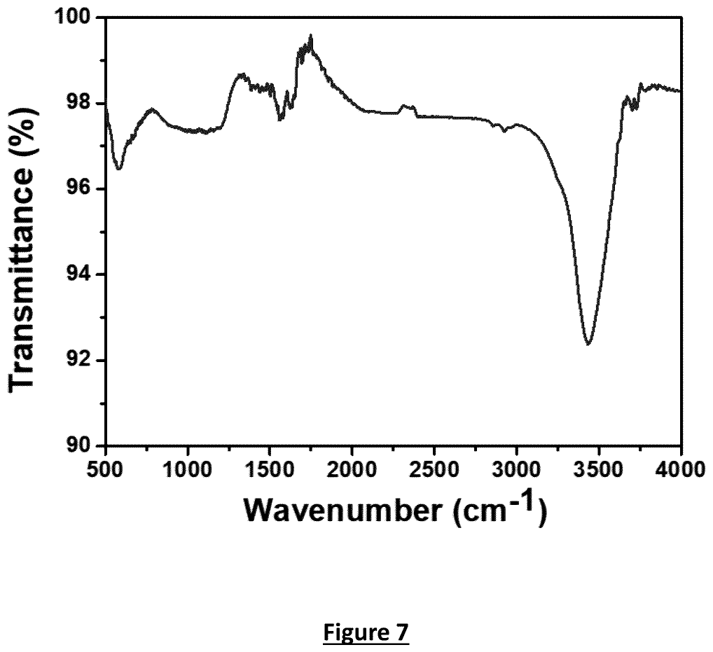

FIG. 7 illustrates an FT-IR spectra of the synthesised CNTs in accordance with an embodiment of the present disclosure. FIG. 7 depicted the FT-IR spectra of the synthesised CNTs. The FT-IR spectra for carbon nanotubes shows a significant band about 1600 cm⁻¹, indicating C═C stretching vibrations in the graphitic structure. CNTs have a graphitic composition and contain sp² hybridised carbon atoms in their walls, as evidenced by this peak. The intensity of this peak is frequently associated with the degree of graphitisation and the quality of the CNTs. Moreover, a band at 3400 cm⁻¹ may indicate the presence of hydroxyl (—OH) groups or water adsorbed on the surface.

### Advantages of the Invention

Sustainability: The approach employs renewable egg-derived precursors, decreasing reliance on petrochemical carbon sources and mitigating environmental effect.
Cost-Effectiveness: The utilisation of eggs, a readily accessible and inexpensive by-product, markedly decreases the expenses associated with CNT synthesis relative to conventional approaches.
Scalability: This approach is scalable, rendering it appropriate for industrial applications in nanotechnology, energy storage, and catalysis.
Environmental Impact: This method generates negligible harmful by-products relative to conventional CNT synthesis procedures, hence enhancing the sustainability of the production process.
Customization: By modifying the ratio of egg white to yolk and the pyrolysis parameters, the characteristics of the resultant CNTs (e.g., length, diameter, surface area) can be customised for particular applications.

### Potential Applications

Energy Storage: The carbon nanotubes generated by this approach are used in lithium-ion batteries, supercapacitors, and various energy storage devices owing to their elevated surface area and electrical conductivity.
Catalysis: Nitrogen-doped carbon nanotubes can serve as effective catalysts or supports for catalytic processes in fuel cells, hydrogen generation, and carbon dioxide reduction.
Composite Materials: Carbon nanotubes can be included into polymer or metal matrix composites to improve mechanical characteristics, electrical conductivity, or thermal stability.

The current invention presents a novel and sustainable approach for producing carbon nanotubes from organic components obtained from eggs, providing a cost-efficient and eco-friendly alternative to traditional CNT synthesis methods. By employing accessible and renewable organic waste materials like egg whites and yolks, the technique obviates the necessity for costly and non-renewable precursor substances, thereby markedly decreasing production expenses. The technology also reduces detrimental by-products and toxic emissions typically linked to conventional CNT production techniques, hence fostering a more environmentally friendly and sustainable manufacturing process.

This idea demonstrates considerable potential for extensive production due to its scalability and adaptability for industrial uses. The capacity to effectively transform egg-derived precursors into superior-quality carbon nanotubes (CNTs) creates novel opportunities for their application across diverse domains, including as energy storage, catalysis, and composite materials. Carbon nanotubes produced via this approach can be included into sophisticated batteries, supercapacitors, fuel cells, and hydrogen storage systems, improving their efficiency and durability. The distinctive characteristics of nitrogen-doped carbon nanotubes derived from egg whites may be very beneficial for use in sensors, electronic devices, and environmental remediation technologies.

The process's adaptability facilitates customisation, permitting the alteration of CNT attributes, including diameter, length, and surface functioning, to meet particular requirements. This enables the customisation of material properties for various applications, including nanomedicine and aerospace engineering. This discovery represents a significant leap in nanotechnology and materials science, offering an environmentally friendly and economically viable solution to the increasing demand for nanoparticles in contemporary industry. This method enhances CNT production and facilitates the advancement of next-generation technologies focused on sustainability and efficiency.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above about specific embodiments. However, the benefits, advantages, solutions to problems, and any component(s) that may cause any benefit, advantage, or solution to occur or become more pronounced are not to be construed as a critical, required, or essential feature or component of any or all the claims.

The invention claimed is:

1. A method for producing carbon nanotubes (CNTs) from egg-derived precursors, comprising:
a) preparing an egg-derived precursor comprising at least one of egg white and egg yolk, wherein preparing the egg-derived precursor comprises at least one of:
i) dehydrating and grinding the egg white or egg yolk into a powder;
ii) hydrothermally treating the egg white or egg yolk to decompose organic constituents into a solution;
iii) blending egg white powder and egg yolk powder in a predetermined ratio; and
iv) hydrothermally treating the blended egg white and egg yolk powder, and wherein the egg white is processed to isolate albumin, wherein the egg yolk is processed to isolate lipids and cholesterol;
b) subjecting the egg-derived precursor to catalytic pyrolysis in an inert atmosphere at a temperature between 900° C. and 1000° C. in the presence of an iron (Fe) catalyst, thereby forming CNTs; and
c) purifying the formed CNTs to remove catalyst particles and unreacted carbon by-products.

2. The method of claim 1, wherein preparing the egg-derived precursor further comprises isolating egg white from egg yolk, wherein the inert atmosphere is provided by argon (Ar) or nitrogen to prevent oxidation, wherein the Fe catalyst is infused into the precursor material, wherein the Fe catalyst is applied onto a support material, wherein the support material is selected from the group consisting of alumina and silica, and wherein purifying the CNTs comprises at least one of acid washing and centrifugation, and wherein the catalytic pyrolysis step is performed in a dual-zone quartz tube furnace, wherein a primary heating zone is maintained between 700° C. to 750° C. for volatilization of amino acid complexes and a secondary zone between 800° C. to 850° C. for alignment of carbonaceous vapor precursors, wherein a feed-forward gas modulation strategy is employed wherein nitrogen is introduced at a baseline flow of 100 sccm for 10 minutes to remove oxygen traces, followed by sequential introduction of hydrogen and methane gases in a ratio of 1:4, respectively, with a cumulative flow rate of 120 sccm, wherein said methane acts both as a reducing and carbon enrichment agent, and wherein a 0.5 wt % ferrocene catalyst is co-fed via sublimation at 200° C. with a ramping delay of 5 minutes to allow precursor pre-carbonization before metal-catalyzed nucleation.

3. The method of claim 1, wherein the egg white powder and egg yolk powder are blended in a predetermined ratio prior to hydrothermal treatment, the method comprising:
a) measuring the egg white and egg yolk powders to achieve a mass ratio of 3:2, corresponding to a protein-to-lipid weight ratio of approximately 2.5:1, based on known proximate compositions of the two fractions;
b) homogenizing the blended powders using a planetary mixer at 150 rpm for 20 minutes to ensure uniform distribution of albumin and lipid components;
c) analyzing the homogenized blend using Kjeldahl nitrogen analysis and Soxhlet lipid extraction to confirm that the total nitrogen content lies within the range of 12-15 wt % and total lipid content within 5-8 wt %;
d) adjusting the blend ratio incrementally by +5% based on deviations from the target nitrogen-to-lipid content window to account for batch-to-batch variability in egg composition;
e) subjecting the optimized blend to hydrothermal treatment at 180° C. for 4 hours in a sealed autoclave to generate a homogeneous nitrogen- and carbon-rich precursor gel; and
f) drying the hydrothermal gel in a vacuum oven at 75° C. for 10 hours, followed by catalytic pyrolysis in an argon atmosphere at 950° C. in the presence of 0.4 wt % iron catalyst supported on silica to form CNTs with tailored nitrogen doping and controlled tube morphology, as validated by elemental CHN analysis and TEM.

4. The method of claim 1, further comprising:
a) pre-conditioning the egg-derived precursor by subjecting the isolated albumin and lipid-rich fractions to a two-stage thermal stabilization process, comprising:
i) heating the albumin and lipid blend to 180° C. for 3 hours in a tubular furnace under a reducing atmosphere of 5% hydrogen in argon to induce molecular crosslinking and thermal denaturation, and
ii) subsequently increasing the temperature to 320° C. for 1 hour under a pure nitrogen atmosphere to initiate low-grade carbonization and suppress spontaneous volatile evolution;
b) analyzing the thermal decomposition profile of the precursor during both stages using simultaneous thermogravimetric analysis (TGA) and differential scanning calorimetry (DSC) to identify peak mass loss rates and optimize dwell times for maximum thermal stability of the intermediate carbonaceous matrix; and
c) drying the thermally stabilized precursor in a vacuum oven at 80° C. for 6 hours prior to catalytic pyrolysis to remove residual moisture and minimize steam-induced disruption of CNT morphology during high-temperature synthesis.

5. The method of claim 1, further comprising:
a) functionalizing the egg-derived precursor with nitrogen-rich dopant compounds by adding urea and melamine in a mass ratio of 3:1 to the hydrothermally treated egg white and yolk solution;
b) stirring the dopant-infused precursor solution at 500 rpm for 1 hour at 60° C. to ensure homogeneous dispersion of nitrogen sources within the protein-lipid matrix;
c) freeze-drying the dopant-infused precursor to obtain a dry nitrogen-doped solid mass; and
d) subjecting the solid mass to catalytic pyrolysis under nitrogen atmosphere at 950° C. in the presence of 0.3 wt % iron nanoparticles to yield nitrogen-doped CNTs with modified graphitic domains for enhanced conductivity and electrochemical activity.

6. The method of claim 1, further comprising:
a) dispersing graphene oxide flakes at a concentration of 0.2 wt % in deionized water via ultrasonication at 40 kHz for 30 minutes;
b) mixing the graphene oxide dispersion with the egg-derived precursor blend comprising powdered egg yolk and egg white in a 1:1 weight ratio;
c) homogenizing the mixture using high-shear mixing at 1000 rpm for 45 minutes to allow interfacial π-π interactions between aromatic amino acid residues and the graphene oxide sheets;
d) drying the resulting composite material under vacuum at 70° C. for 8 hours to form a graphene-integrated precursor powder; and
e) subjecting the dried precursor to catalytic pyrolysis in argon at 980° C. with iron catalyst support on alumina to form coaxial CNT-graphene nanostructures with enhanced charge transport characteristics.

7. The method of claim 1, further comprising:
a) adjusting the pH of the blended egg white and yolk hydrolysate to a controlled range of 7.2 to 7.6 using ammonium bicarbonate as a buffering agent to promote Maillard reaction pathways;
b) heating the pH-adjusted mixture to 135° C. under an oxygen-deficient atmosphere (O₂ concentration <1%) for 2 hours to induce thermochemical conversion of protein and lipid fractions into heterocyclic intermediates;
c) monitoring the Maillard reaction progression using Fourier-transform infrared (FTIR) spectroscopy, focusing on absorption peaks at 1540 cm⁻¹ and 1635 cm⁻¹ corresponding to imidazole ring and Schiff base formation; and
d) terminating the reaction when the peak intensity ratio (I₁₅₄₀/I₁₆₃₅) reaches a value between 0.85 and 1.05, followed by vacuum drying at 60° C. for 12 hours to preserve the dopant-rich matrix for subsequent carbonization.

8. The method of claim 1, further comprising:
a) adding ethylenediaminetetraacetic acid (EDTA) at a concentration of 0.25 M to the egg-derived precursor blend during hydrothermal treatment;
b) maintaining the chelating reaction at 70° C. for 2 hours under continuous stirring to form metal-EDTA complexes with naturally occurring calcium, magnesium, and iron ions;
c) centrifuging the solution at 8000 rpm for 10 minutes to separate unbound components and obtain a clarified chelated precursor suspension;
d) drying the chelated precursor at 90° C. for 10 hours under vacuum conditions to yield a fine powder; and
e) subjecting the powder to catalytic pyrolysis in a dual-zone furnace with temperature zones set at 750° C. and 850° C. to obtain CNTs with narrow wall numbers and controlled inner diameters.

9. The method of claim 1, further comprising:
a) suspending the egg-derived precursor blend in a 3 wt % aqueous gelatin solution maintained at 45° C. for 20 minutes to induce hydrogen bonding interactions and form a uniform viscoelastic matrix;
b) casting the gelatin-precursor mixture into cylindrical molds and subjecting it to unidirectional freezing by placing the mold base in contact with a liquid nitrogen-cooled copper substrate, resulting in the formation of vertically aligned ice-templated microchannels;
c) freeze-drying the casted samples at −50° C. under vacuum for 48 hours to sublimate the ice crystals and retain aligned porosity;
d) pyrolyzing the freeze-dried structures in a horizontal tubular furnace at 920° C. for 1 hour under flowing nitrogen in the presence of 0.2 wt % iron catalyst deposited on silica spheres; and
e) producing vertically aligned CNTs that exhibit capillary-guided orientation due to the preserved anisotropic porosity of the freeze-cast hydrogel template.

10. The method of claim 1, further comprising:
a) electrostatically atomizing the egg-derived precursor solution using a high-voltage DC field of 16 kV to generate microdroplets with a mean diameter below 10 μm;
b) depositing the atomized droplets onto a rotating ceramic drum pre-heated to 250° C. to achieve partial carbonization and shell-core microsphere formation through rapid solvent evaporation and protein-lipid phase separation;
c) collecting the microspheres and subjecting them to a staged heating protocol comprising 1 hour at 400° C. and then 30 minutes at 800° C. under argon atmosphere to induce thermal cracking and hierarchical pore formation;
d) introducing 5 wt % of a metal-organic framework (MOF) precursor selected from ZIF-67 into the microsphere matrix prior to final pyrolysis; and
e) decomposing the MOF during pyrolysis to yield embedded cobalt nanoparticles, thereby initiating radially outward CNT growth from the microsphere cores to form flower-like multi-walled nanotube architectures with dual-modal porosity.

11. The method of claim 1, further comprising:
a) exposing the dry egg-derived precursor powder to xenon difluoride (XeF₂) vapor under vacuum conditions of 10⁻⁴ Torr for 2 hours to achieve partial fluorination of peptide backbone nitrogen sites;
b) storing the fluorinated powder in an inert argon environment for at least 12 hours to stabilize chemical modifications prior to pyrolysis;
c) mixing the fluorinated precursor with 1 wt % amorphous boron powder and ball milling the mixture at 400 rpm for 6 hours in a sealed nitrogen-purged jar using zirconia balls;
d) loading the milled powder into a high-temperature furnace and performing pyrolysis at 940° C. for 45 minutes in a nitrogen atmosphere, using an iron catalyst supported on alumina spheres; and
e) producing boron-doped and fluorine-functionalized CNTs exhibiting p-type conductivity and defect-mediated reactivity, with an average I_D/I_G ratio exceeding 1.2 as verified via Raman spectroscopy.

12. The method of claim 1, further comprising:
a) supplementing the hydrothermally treated egg precursor with tyrosine and phenylalanine at a combined concentration of 0.4 wt % to enhance aromatic carbon source content;
b) adjusting the pH of the solution to 6.9 using sodium carbonate to optimize the protonation state of aromatic residues and promote π-π stacking during thermal treatment;
c) drying the modified precursor to a powder form and subjecting it to catalytic pyrolysis at 900° C. under nitrogen with 0.5 wt % iron catalyst co-fed via vaporized ferrocene;
d) continuously monitoring the reactor exhaust during pyrolysis using online mass spectrometry to quantify real-time ion intensities of C₂H₂⁺, CO⁺, and NH₃⁺ fragments; and
e) dynamically adjusting the furnace heating rate and carrier gas flow using an AI-based closed-loop feedback controller trained to minimize variation in CNT diameters based on detected fragment concentrations and associated kinetic models.

13. The method of claim 1, wherein the carbon nanotube nucleation and elongation phase is dynamically modulated using pulse-controlled microwave plasma discharges in a vacuum reactor maintained at 10⁻³ Torr, wherein the plasma is applied at a frequency of 2.45 GHz with pulsing intervals of 100 ms ON and 400 ms OFF over a total duration of 30 minutes to prevent excessive graphitic clustering, wherein an in situ optical emission spectrometer monitors the relative CN*, C₂*, and CH* radical intensities to optimize precursor fragmentation levels, and wherein the elongation directionality is induced by electrostatic field-assisted alignment at ±2 kV/cm to promote the growth of straight, multi-walled CNTs with uniform diameters ranging between 6 to 10 nm.

14. The method of claim 1, wherein prior to pyrolysis, the blended egg yolk and egg white powders are subjected to chemical pre-activation using a 1 M potassium hydroxide (KOH) solution under continuous magnetic stirring at 300 rpm for 2 hours at 60° C., wherein the wet mass is then filtered and vacuum dried at 80° C. for 6 hours, wherein the KOH pre-treatment induces porosity and edge site exposure in the carbon matrix, increasing the specific surface area to at least 400 m²/g, and wherein the resultant porous mass is impregnated with 2 wt % cobalt nitrate, followed by air drying and low-temperature calcination at 300° C. for 1 hour to form catalytic Co₃O₄ clusters prior to high-temperature CNT growth;
wherein the CNT synthesis is carried out in a fluidized bed reactor using inert zirconia beads of 100 μm diameter to promote uniform thermal contact and minimize local hot spots, wherein the temperature profile is dynamically adjusted using a PID-controlled segmented heating coil such that the axial temperature gradient does not exceed 15° C. across any 5 cm segment, wherein a pre-mixed gas stream of acetylene and ammonia in a 3:1 ratio is fed into the chamber at a flow rate of 80 sccm; and

15. The method of claim 1, wherein the thermal decomposition step is preceded by a controlled Maillard reaction stage between proteinaceous and lipid fractions of the egg-derived precursor, wherein said Maillard reaction is induced by maintaining the blend at a temperature of 130° C.±2° C. under a low oxygen environment (≤1% O₂ by volume) for a duration of 2 hours, wherein this reaction leads to the formation of intermediate heterocyclic compounds and nitrogenous polymers that act as internal carbon-nitrogen dopant sources during pyrolysis, wherein the extent of the Maillard reaction is monitored via real-time Fourier-transform infrared spectroscopy (FTIR) using absorption peaks at 1540 cm⁻¹ and 1635 cm⁻¹ indicative of imidazole ring and Schiff base formation, respectively, and wherein the intensity ratio of these peaks is adjusted by varying precursor pH within a controlled range of 6.8 to 8.1 to tune nitrogen doping profiles in the resulting CNT structure.

16. The method of claim 1, wherein a dual-function bimetallic catalyst system comprising iron (Fe) and molybdenum (Mo) nanoparticles is synthesized in situ by decomposing ferric acetylacetonate and ammonium molybdate in a 1:0.8 molar ratio, wherein the catalytic particles are deposited via aerosol-assisted chemical vapor deposition (AACVD) by atomizing a methanolic suspension of the two precursors at a flow rate of 0.2 mL/min, wherein this catalyst system enables both tip-growth and base-growth mechanisms within the same reactor zone, wherein the segregation of growth modes is driven by differential thermal gradients of 5° C./cm along the reactor axis and by varying local carbon feed concentrations via pulsed acetylene injection at 15-second intervals, and wherein this leads to a mixed population of CNTs with aspect ratios ranging from 10³ to 10⁵ and spatial orientation anisotropy measurable by polarized SEM imaging, and wherein the pyrolysis temperature ramping is executed in a non-linear segmented profile comprising: (i) an initial slow ramp from ambient to 400° C. at 2° C./min to facilitate gradual protein carbonization, (ii) a rapid ramp from 400° C. to 800° C. at 10° C./min for vapor-phase transformation, and (iii) a final hold at 850° C. for 45 minutes to allow for tubular crystallization, wherein during the rapid ramp phase, argon is introduced at 80 sccm along with a temporary 5-minute spike of isopropanol vapor to act as a secondary carbon enhancer and hydroxyl radical scavenger, wherein the hold period is dynamically extended up to 60 minutes if in situ laser Raman measurements reveal a D/G intensity ratio greater than 1.5, and wherein feedback control for this adjustment is executed through a closed-loop system that integrates thermogravimetric analysis (TGA) data with real-time Raman spectral input.

17. The method of claim 1, wherein the egg-derived precursor blend is modified with a chelating agent selected from the group consisting of ethylenediaminetetraacetic acid (EDTA), citric acid, or phytic acid at a concentration of 0.1-0.3 M, wherein the chelating agent is added to pre-complex the calcium, magnesium, and iron ions inherently present in the egg matrix, wherein such chelation modulates the catalytic nucleation points by controlling metal aggregation behavior under heat, wherein this leads to the formation of CNTs with narrow inner diameters between 1.5 to 3 nm, and wherein the wall number is limited to 2-3 layers as validated via high-resolution transmission electron microscopy (HR-TEM), with inter-wall spacing in the range of 0.34 to 0.36 nm, wherein post-synthesis surface modification of the CNTs is carried out by immersing the pyrolytically grown material in a 1:1 v/v solution of nitric acid and sulfuric acid at 60° C. for 4 hours under continuous sonication at 40 kHz, wherein the acid treatment introduces —COOH and —OH functional groups onto the CNT sidewalls, thereby enhancing hydrophilicity and dispersibility in aqueous media, wherein the functionalized CNTs are filtered, washed to pH neutral, and further reacted with (3-aminopropyl)triethoxysilane (APTES) in toluene at 80° C. for 2 hours to introduce terminal amine groups; and
wherein prior to pyrolysis, the precursor blend is suspended in a 3 wt % aqueous gelatin solution at 40° C. for 15 minutes to form a viscoelastic hydrogel matrix, wherein this hydrogel is subjected to directional freeze-casting by immersion in a liquid nitrogen-cooled copper plate, resulting in vertically aligned ice-crystal templating, wherein freeze-dried samples retain the templated porosity, which guides the vertical orientation of CNT growth during thermal decomposition due to capillary-induced alignment effects.

18. The method of claim 1, wherein the egg-derived precursor is supplemented with 0.2 to 0.5 wt % of graphene oxide flakes dispersed in deionized water and sonicated for 30 minutes prior to drying, wherein the graphene oxide serves as a 2D nucleation scaffold that facilitates π-π stacking with aromatic residues formed during the decomposition of tyrosine and phenylalanine in egg proteins, wherein the CNTs grow as coaxial shells around the graphene oxide domains during thermal processing at 800° C., wherein the composite structure is characterized by a hybrid tubular-platelet morphology with enhanced electron mobility (>10⁴ S/m) due to synergistic edge conduction pathways, and wherein a continuous real-time mass spectrometric monitoring system is integrated with the pyrolysis chamber via a quartz sampling line and ion trap detector, wherein molecular fragments such as C₂H₂⁺, NH₃⁺, and CO⁺ are tracked to infer carbon-nitrogen rearrangement kinetics during pyrolytic decomposition.

19. The method of claim 1, wherein the precursor powder is electrostatically sprayed onto a rotating ceramic drum pre-heated to 250° C. to induce partial carbonization prior to final pyrolysis, wherein the spraying is done using a high-voltage DC field of 15-18 kV, producing droplets with mean diameters below 10 μm, wherein the resulting shell-core microspheres undergo controlled thermal cracking during ramp-up heating, wherein this yields a hierarchically porous CNT network with dual-modal pore distribution (micropores<2 nm and mesopores 5-10 nm), and wherein the BET surface area is enhanced to >800 m²/g without the use of external templates or pore formers, and wherein a metal-organic framework (MOF) precursor, selected from ZIF-67 or MIL-101, is introduced at 3-6 wt % into the egg powder matrix during blending, wherein the MOF acts as both a secondary catalyst precursor and as a sacrificial structure for porosity modulation, wherein the MOF decomposes during pyrolysis to yield in situ cobalt or iron nanoparticles embedded within graphitized carbon shells, wherein the growth of CNTs proceeds radially outward from these embedded metal sites, producing flower-like multi-branched CNT clusters.

20. The method of claim 1, wherein the surface energy of the precursor powder is modified through fluorination by exposing the powder to xenon difluoride (XeF₂) vapor under vacuum (10⁻⁴ Torr) for 2 hours, wherein this causes partial fluorination of peptide backbone sites, reducing the decomposition onset temperature by up to 50° C.; and wherein the pyrolysis process is preceded by mechanochemical activation via high-energy ball milling of the egg-based precursor with 1 wt % amorphous boron for 6 hours at 400 rpm in a nitrogen atmosphere, wherein this step induces localized plastic deformation and bond rupture leading to increased chemical reactivity, wherein the boron acts as both a structural defect promoter and a mild catalyst dopant, resulting in p-type doping of the CNTs.
